(19) United States
(12) Patent Application Publication
(10) Pub. No.: US 2008/0074354 A1
(43) Pub. Date: Mar. 27, 2008

(54) Plasma display apparatus

(75) Inventors: Kazuo Yahagi, Chuo-shi (JP); Mitsunori Taguchi, Chuo-shi (JP); Kazuhiro Kanai, Chuo-shi (JP); Yuichi Sakai, Chuo-shi (JP); Mitsushi Kitagawa, Chuo-shi (JP); Yoshichika Sato, Chuo-shi (JP); Takatoshi Shoji, Chuo-shi (JP); Motofumi Ikeda, Chuo-shi (JP)

Correspondence Address: DRINKER BIDDLE & REATH (DC), 1500 K STREET, N.W., SUITE 1100, WASHINGTON, DC, 20005-1209, US

(73) Assignee: PIONEER CORPORATION

(21) Appl. No.: 11/898,269

(22) Filed: Sep. 11, 2007

(30) Foreign Application Priority Data
Sep. 21, 2006 (JP) 2006-255632
Oct. 12, 2006 (JP) 2006-278770

(51) Int. Cl. G09G 3/28

(52) U.S. Cl. 345/63; 345/60

(57) ABSTRACT

A plasma display apparatus in which in an address period, address discharge is generated in each display cell of a display panel selectively in accordance with pixel data based on a video signal, and in a sustain period, a sustain pulse for sustain discharge is applied between row electrodes constituting the row electrode pairs by a predetermined number of times which is preset for each of the subfields, and a length of a front-edge period of the sustain pulse to be applied is adjusted subfield by subfield in accordance with a load level in each subfield.

### BACKGROUND OF THE INVENTION

1. Field of the Invention

The present invention relates to a plasma display apparatus using a plasma display panel, and a method for driving the plasma display panel.

2. Description of the Related Background Art

Plasma display panels of AC type (alternating-current discharge type) have recently been put into production as thin-model displays. A plasma display panel contains two substrates, i.e., a front glass substrate and a rear glass substrate which are opposed to each other with a predetermined gap therebetween. A plurality of pairs of row electrodes which are paired with each other and extended in parallel are formed on the inner surface (the side opposed to the rear glass substrate) of the foregoing front glass substrate, or a display surface, as pairs of sustain electrodes. A plurality of column electrodes are formed on the rear glass substrate as address electrodes so as to extend orthogonal to the pairs of row electrodes, and phosphors are further applied thereto. When viewed from the foregoing display-surface side, display cells corresponding to pixels are formed at intersections of the pairs of row electrodes and the column electrodes. The plasma display panel is subjected to gradation driving based on a subfield method for the sake of achieving halftone display luminance corresponding to an input video signal.

In the gradation driving based on the subfield method, a display drive for a single field of a video signal is performed in a plurality of individual subfields to which respective intended numbers of times (or periods) of light emission are assigned. In each subfield, an address stage and a sustain stage are performed in succession. At the address stage, selective discharge is generated between the row electrodes and the column electrodes of respective display cells selectively in accordance with the input video signal, thereby forming (or erasing) a predetermined amount of wall charge. At the sustain stage, sustain pulses are applied to each row electrode so that display cells having the predetermined amount of wall charge formed therein alone generate discharge repeatedly to sustain the light-emitting state resulting from the discharge. An initialization stage is also performed at least in the first subfield, prior to the address stage. In the initialization stage, reset discharge is generated between the paired row electrodes in all the display cells, thereby initializing the amount of wall charge remaining in each display cell.

If a lot of display cells are set to an ON state, and the application of sustain pulses causes discharge in the large number of cells almost at the same time in a sustain stage, then a large amount of current instantaneously flows to deform the voltage waveforms of the sustain pulses. As a result, the display cells may undergo respective different values of voltage during discharge depending on subtle differences in the start timing of discharge. This has produced variation in the discharge intensity, possibly deteriorating the display quality due to luminance variation.

Moreover, in the plasma display panel, the amounts of wall charges to be formed in the respective display cells change because of variation in panel temperature, secular change, etc. There has thus been the problem of discharge variation ascribable to the changes in the amounts of wall charges, with deterioration in display quality.

For the problem, there has been proposed a driving method in which a rear edge of the last sustain pulse to be applied in a sustain stage is shaped to have a first voltage decrease period Tb1 where its potential decreases gradually, a constant voltage period Tb2 where the potential is constant, and a second voltage decrease period Tb3 where the potential decreases more slowly than in the first voltage decrease period Tb1 (see Japanese Patent Laid-Open Publication No. 2005-43397). That is, the pulse rear edge of the sustain pulse is provided with the constant voltage period Tb2 where the potential decrease stops temporarily, thereby stabilizing the state of the wall charges. Consequently, the amount of wall charge in each display cell is adjusted to an appropriate amount in the constant voltage period Tb2 at the rear edge of the last sustain pulse regardless of the panel temperature, secular change, or other factors.

The greater the number of display cells to generate sustain discharge, i.e., display cells in the ON state is, the higher the discharge current to flow for the sustain discharge becomes accordingly. The increase in the lighting load level can lower the pulse voltage of the sustain pulse, deforming the waveform at the rear edge of the sustain pulse (IPYE) as described above. This has caused the problem that it is no longer possible to adjust the amount of wall charge in each of the display cells to an appropriate amount at the rear edge of the sustain pulse (IPYE), thereby making it difficult to generate discharge with stability thereafter.

### SUMMARY OF THE INVENTION

It is therefore an object of the present invention to provide a plasma display apparatus and a method for driving a plasma display panel which are capable of generating stable discharge regardless of a lighting load level, so that display quality can be improved by avoiding variation in discharge intensity of each display cell.

A plasma display apparatus according to the present invention is an apparatus for performing a gradation display on a plasma display panel by constructing a plurality of subfields including an address period and a sustain period in each field of an input video signal, the plasma display panel having a plurality of row electrode pairs constituting a plurality of display lines and a plurality of column electrodes that intersect with each of the row electrode pairs so as to form display cells at the intersection portions, the apparatus comprising: an address portion which generates, in the address period, address discharge in each of the display cells selectively in accordance with pixel data based on the video signal; and a sustain portion which applies, in the sustain period, a sustain pulse to between row electrodes constituting the row electrode pairs by a predetermined number of times which is preset for each of the subfields, wherein the sustain portion sets a length of a front-edge period of the applied sustain pulse in accordance with a load level of the plasma display panel in each of the subfields.

A method for driving a plasma display panel according to the present invention is a method for performing a gradation display on a plasma display panel by constructing a plurality of subfields including an address period and a sustain period in each field of an input video signal, wherein a length of a front-edge period of a sustain pulse applied in the sustain period is set in accordance with a load level of the plasma display panel in each of the subfields.

According to the plasma display apparatus of the present invention and the driving method of the present invention, the length of the front-edge period of the sustain pulse to be applied in each subfield is set in accordance with the load level in each subfield. Even if a large number of display cells produce sustain discharge, it is therefore possible to create some variations in the timings of the sustain discharges in respective display cells. It is possible to generate sustain pulses without deforming in waveform and to suppress decrease in the discharge intensity of each display cell. Therefore, luminance variation can be improved for enhanced display quality.

Another plasma display apparatus according to the present invention is an apparatus for performing a gradation display on a plasma display panel by constructing a plurality of subfields including an address period and a sustain period in each field of an input video signal, the plasma display panel having a plurality of row electrode pairs constituting a plurality of display lines and a plurality of column electrodes that intersect with each of the row electrode pairs so as to form display cells at the intersection portions, the apparatus comprising: an address portion which generates, in the address period, address discharge in each of the display cells selectively in accordance with pixel data based on the video signal; and a sustain portion which applies, in the sustain period, a sustain pulse to between row electrodes constituting the row electrode pairs by a predetermined number of times which is preset for each of the subfields, wherein the sustain portion sets a length of a front-edge period of the applied sustain pulse in accordance with a first load level of the plasma display panel for each of the subfields and a second load level for each display line of the plasma display panel.

Another driving method according to the present invention is a method for performing a gradation display on a plasma display panel by constructing a plurality of subfields including an address period and a sustain period in each field of an input video signal, wherein a length of a front-edge period of the applied sustain pulse is set in accordance with a first load level of the plasma display panel for each of the subfields and a second load level for each display line of the plasma display panel.

According to the plasma display apparatus of the present invention and the driving method of the present invention, the length of the front-edge period of the sustain pulse to be applied in each subfield is set in accordance with the load level for each subfield and the load level for each display line in the subfield. If the load levels in respective subfields are the same but with load distribution that can easily cause luminance variation, the front-edge periods of the sustain pulses are therefore adjusted for appropriate discharge intensities. Thus, this contributes to a further improvement of the luminance variation.

A method for driving a plasma display panel according to the present invention is a method for dividing a display period for each field of an input video signal into a plurality of subfields, and driving a plasma display panel for each of the subfields, the plasma display panel having a plurality of row electrode pairs constituting a plurality of display lines and a plurality of column electrodes that intersect with each of the row electrode pairs so as to form display cells at the intersection portions, the method comprising the steps of: executing, in each of the subfields, an address stage for setting each of the display cells to either one of a lighting mode and an extinction mode in accordance with pixel data on each pixel corresponding to the input video signal, and a sustain stage for applying a sustain pulse to between row electrodes constituting the row electrode pairs by a predetermined number of times which is preset for each of the subfields, thereby making display cells in the lighting mode alone generate sustain discharge repeatedly, wherein: a rear edge of a last one of the sustain pulses applied in the sustain stage is composed of a first potential decrease period where a potential to be applied to the row electrodes decreases gradually with a lapse of time, a constant potential period subsequent to the first potential decrease period, where the potential to be applied to the row electrodes remains constant during a predetermined period, and a second potential decrease period subsequent to the constant potential period, where the potential to be applied to the row electrodes decreases gradually with a lapse of time; and in each of the subfields, the total number of display cells which are in the lighting mode is measured as a lighting load level, and a length of the first potential decrease period is adjusted in accordance with the lighting load level.

According to the plasma display panel driving method of the present invention, the rear edge of the last sustain pulse, which is composed of the first potential decrease period where the potential decreases gradually with a lapse of time, the constant potential period where the potential remains constant for a predetermined period, and the second potential decrease period where the potential decreases gradually with a lapse of time, is subjected to waveform adjusting processing. That is, the first potential decrease period of the last sustain pulse in the sustain stage of each subfield is adjusted in length based on the total number of display cells in the lighting mode in the subfield as a lighting load level. More specifically, the ratio of potential decrease with a lapse of time in the first potential decrease period changes in accordance with the lighting load level of the display cells. This results in potential variation in the constant potential period, making it difficult to control the wall charges in each display cell P to an appropriate amount. For solving this problem, the length of the first potential decrease period is adjusted based on the lighting load level, so that the potential in the constant potential period of the last sustain pulse is maintained to a predetermined potential. Therefore, it is possible to generate a stable discharge all the time regardless of the lighting load level.

### BRIEF DESCRIPTION OF THE DRAWINGS

FIG. 1 is a diagram illustrating an outline configuration of a plasma display apparatus according to the first invention;

FIG. 2 is a front view schematically illustrating the internal configuration of PDP seen from the display surface side of the device shown in FIG. 1;

FIG. 3 is a diagram illustrating a cross section on line V3-V3 shown in FIG. 2;

FIG. 4 is a diagram illustrating a cross section on line W2-W2 shown in FIG. 2;

FIG. 5 is a diagram illustrating magnesium oxide monocrystals having a cubic polycrystal structure;

FIG. 6 is a diagram illustrating a magnesium oxide monocrystal having a cubic polycrystal structure;

FIG. 7 is a diagram illustrating a form when magnesium oxide monocrystal powder is attached to the surface of a dielectric layer and an increased dielectric layer to form a magnesium oxide layer;

FIG. 8 is a diagram illustrating an exemplary light emission driving sequence adopted in the plasma display apparatus;

FIG. 9 is a diagram illustrating light emission patterns of the plasma display apparatus;

FIG. 10 is a diagram illustrating various drive pulses to be applied to PDP and application timing thereof in accordance with the light emission driving sequence shown in FIG. 8;

FIG. 11 is a graph illustrating the relationship between the particle diameter of magnesium oxide monocrystal powder and the wavelength of CL light emission;

FIG. 12 is a graph illustrating the relationship between the particle diameter of magnesium oxide monocrystal powder and the intensity of CL light emission at 235 nm;

FIG. 13 is a diagram illustrating a discharge probability when no magnesium oxide layer is constructed in a display cell, a discharge probability when a magnesium oxide layer is constructed by traditional vapor deposition, and a discharge probability when a magnesium oxide layer of a polycrystal structure is constructed;

FIG. 14 is a diagram illustrating the correspondence between CL light emission intensity at a 235-nm peak and discharge delay time;

FIG. 15 is a circuit diagram illustrating a specific configuration of an X-row electrode drive circuit and a Y-row electrode drive circuit in the device shown in FIG. 1;

FIG. 16 is a diagram illustrating switching operations and voltage waveforms of each electrode in the drive circuit shown in FIG. 15;

FIGS. 17A and 17B are drawings showing the specific waveforms of sustain pulses and switching operations;

FIG. 18 is a diagram showing the schematic configuration of a plasma display apparatus according to the second invention;

FIG. 19 is a diagram showing the schematic configuration of a plasma display apparatus according to the third invention;

FIG. 20 is a chart showing emission patterns in respective gradation levels of the plasma display apparatus shown in FIG. 19;

FIG. 21 is a diagram illustrating an exemplary light emission driving sequence adopted in the plasma display apparatus shown in FIG. 19;

FIG. 22 is a chart showing various types of driving pulses to be applied to the PDP 110 according to the light emission driving sequence shown in FIG. 21 and the timing of application thereof;

FIG. 23 is a diagram showing an example of the internal configuration of the Y electrode driver in the apparatus of FIG. 19;

FIG. 24 is a waveform chart showing switching sequences SSY and SSYE for generating sustain pulses IP and IPE;

FIG. 25 is a chart showing the waveform of a rear edge of the sustain pulse IPE which varies in accordance with the amount of lighting load;

FIGS. 26A to 26C are charts for explaining a waveform adjusting operation on the rear edge of the sustain pulse IPE;

FIG. 27 is a diagram showing another example of the light emission driving sequence to be employed in the plasma display apparatus shown in FIG. 19; and

FIG. 28 is a chart showing emission patterns in respective gradation levels when exercising a drive according to the light emission driving sequence shown in FIG. 27.

### DETAILED DESCRIPTION OF THE INVENTION

Hereinafter, embodiments of the present invention will be described in detail with reference to the drawings.

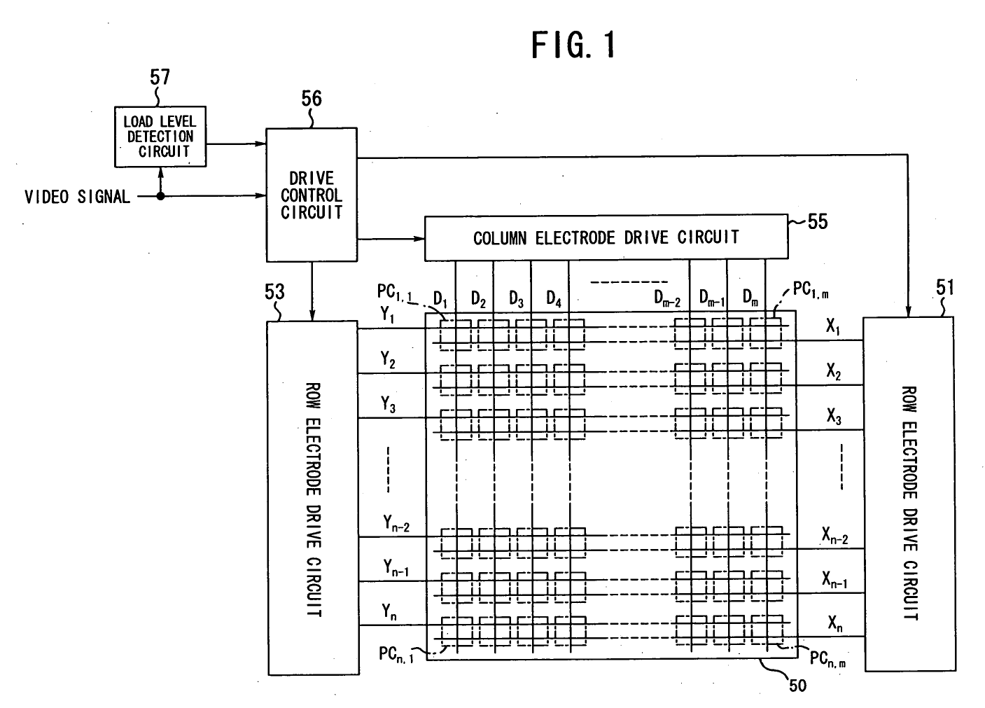

FIG. 1 is a diagram showing the schematic configuration of a plasma display apparatus according to the present invention.

As shown in FIG. 1, the plasma display apparatus comprises a plasma display panel or PDP 50, an X-row electrode driving circuit 51, a Y-row electrode driving circuit 53, a column electrode driving circuit 55, a drive control circuit 56, and a load level detection circuit 57.

In the PDP 50, column electrodes D₁ to Dₘ are extended and arranged in the longitudinal direction (vertical direction) of a two-dimensional display screen, and row electrodes X₁ to Xₙ and row electrodes Y₁ to Yₙ are extended and arranged in the lateral direction (the horizontal direction) thereof. The row electrodes X₁ to Xₙ and row electrodes Y₁ to Yₙ form row electrodes pairs (Y₁, X₁), (Y₂, X₂), (Y₃, X₃), . . . , (Yₙ, Xₙ) which are paired with those adjacent to each other and which serve as the first display line to the nth display line in the PDP 50. In each intersection part of the display lines with the column electrodes D₁ to Dₘ (areas surrounded by dashed lies in FIG. 1), a display cell PC which serves as a pixel is formed. More specifically, in the PDP 50, the display cells PC_{1,1} to PC_{1,m} belonging to the first display line, the display cells PC_{2,1} to PC_{2,m} belonging to the second display line, and the display cells PC_{n,1} to PC_{n,m} belonging to the nth display line are each arranged in a matrix.

Each of the column electrodes D₁ to Dₘ of the PDP 50 is connected to the column electrode drive circuit 55, each of the row electrodes X₁ to Xₙ is connected to the X-row electrode drive circuit 51, and each of the row electrodes Y₁ to Yₙ is connected to the Y-row electrode drive circuit 53.

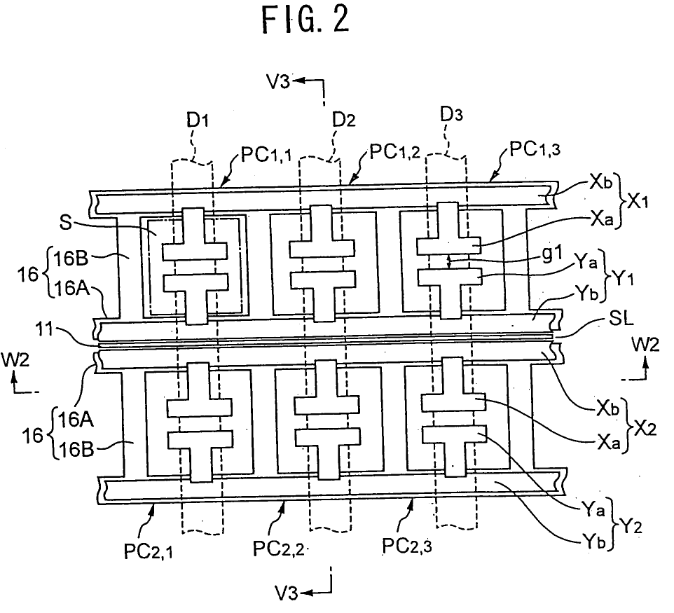

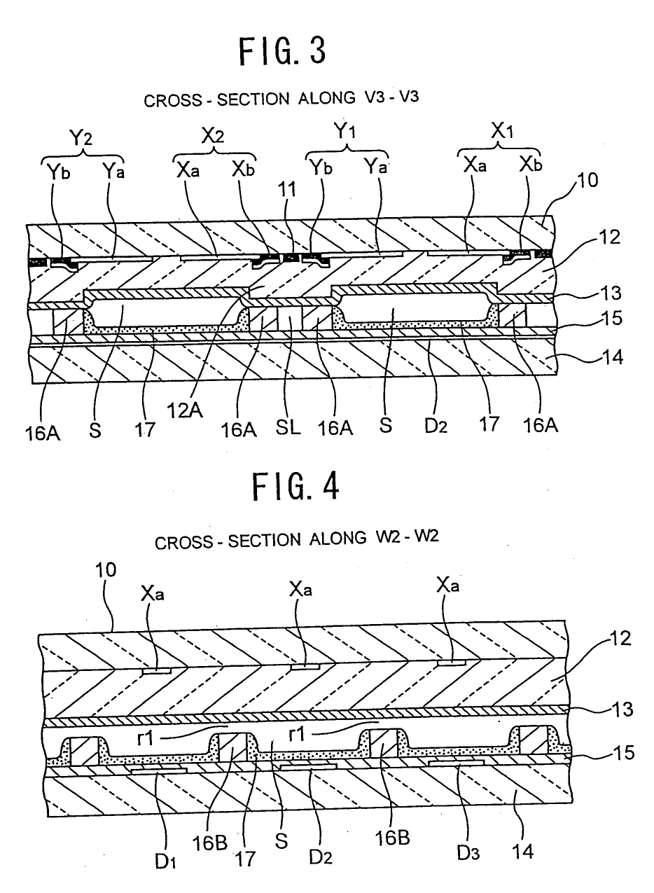

FIG. 2 is a front view schematically illustrating the internal configuration of the PDP 50 seen from the display surface side. FIG. 2 depicts each of the intersection parts of each of the column electrodes D₁ to D₃ with the first display line (Y₁, X₁) and the second display line (Y₂, X₂) in the PDP 50. FIG. 3 depicts a diagram illustrating a cross section of the PDP 50 at a line V3-V3 in FIG. 2, and FIG. 4 depicts a diagram illustrating a cross section of the PDP 50 at a line W2-W2 in FIG. 2.

As shown in FIG. 2, each of the row electrodes X is configured of a bus electrode Xb (main portion) extended in the horizontal direction in the two-dimensional display screen and a T-shaped transparent electrode Xa (projected portion) formed as contacted with the position corresponding to each of the display cells PC on the bus electrode Xb. Each of the row electrodes Y is configured of a bus electrode Yb extended in the horizontal direction of the two-dimensional display screen and a T-shaped transparent electrode Ya formed as contacted with the position corresponding to each of the display cells PC on the bus electrode Yb. The transparent electrodes Xa and Ya oppose each other via a discharge gap g1 which has a predetermined length. The transparent electrodes Xa and Ya are formed of a transparent conductive film such as ITO, and the bus electrodes Xb and Yb are formed of a metal film, for example. As shown in FIG. 3, for the row electrode X formed of the transparent electrode Xa and the bus electrode Xb, and for the row electrode Y formed of the transparent electrode Ya and the bus electrode Yb, the front sides thereof are formed on the rear side of a front transparent substrate 10 to be the display surface of the PDP 50. The transparent electrodes Xa and Ya in each row electrode pair (X, Y) are extended to the counterpart row electrode side to be paired, and each have a wide portion near the discharge gap g1, and a narrow portion connecting between the wide portion and the bus electrode. The flat tops of the wide portions of the transparent electrodes Xa and Ya are faced to each other through the discharge gap g1. Moreover, on the rear side of the front transparent substrate 10, a black or dark light absorbing layer (shade layer) 11 extended in the horizontal direction of the two-dimensional display screen is formed between a pair of the row electrode pair (X₁, Y₁) and the row electrode pair (X₂, Y₂) adjacent to this row electrode pair. Furthermore, on the rear side of the front transparent substrate 10, a dielectric layer 12 is formed so as to cover the row electrode pair (X, Y). On the rear side of the dielectric layer 12 (the surface opposite to the surface to which the row electrode pair is contacted), an increased dielectric layer 12A is formed at the portion corresponding to the area where a light absorbing layer 11 and the bus electrodes Xb and Yb adjacent to the light absorbing layer 11 are formed as shown in FIG. 3. On the surface of the dielectric layer 12 and the increased dielectric layer 12A, a magnesium oxide layer 13 including vapor phase magnesium oxide (MgO) monocrystal powder, described later, is formed.

On the other hand, on a rear substrate 14 disposed in parallel with the front transparent substrate 10, each of the column electrodes D is formed as extended in the direction orthogonal to the row electrode pair (X, Y) at the position facing the transparent electrodes Xa and Ya in each row electrode pair (X, Y). On the rear substrate 14, a white column electrode protective layer 15 which covers the column electrode D is further formed. On the column electrode protective layer 15, partition 16 is formed. The partition 16 is formed in a ladder shape of a lateral wall 16A extended in the lateral direction of the two-dimensional display screen at the position corresponding to the bus electrodes Xb and Yb of each row electrode pair (X, Y), and of a vertical wall 16B extended in the longitudinal direction of the two-dimensional display screen at the middle between the column electrodes D adjacent to each other. In addition, the partition 16 in a ladder shape as shown in FIG. 2 are formed at every display line of the PDP 50, and a space SL exists between the partitions 16 adjacent to each other as shown in FIG. 2. Besides, the partitions 16 in a ladder shape partition the display cells PC including a discharge space S, and the transparent electrodes Xa and Ya, each of them is separated. In the discharge space S, discharge gas including xenon gas is filled. The discharge gas contains 10% by volume or more of xenon gas sealed within the discharge space S. On the side surface of the lateral wall 16A, the side surface of the vertical wall 16B, and the surface of the column electrode protective layer 15 in each of the display cells PC, a fluorescent material layer 17 is formed so as to cover the entire surfaces thereof as shown in FIG. 3. The fluorescent material layer 17 is actually formed of three types of fluorescent materials: a fluorescent material for red light emission, a fluorescent material for green light emission, and a fluorescent material for blue light emission. The discharge space S and the space SL in each of the display cells PC are closed to each other by abutting the magnesium oxide layer 13 against the lateral wall 16A as shown in FIG. 3. On the other hand, as shown in FIG. 4, since the vertical wall 16B is not abutted against the magnesium oxide layer 13, a space r1 exists therebetween. More specifically, the discharge spaces S of each of the display cells PC adjacent to each other in the lateral direction of the two-dimensional display screen communicate with each other through the space r1.

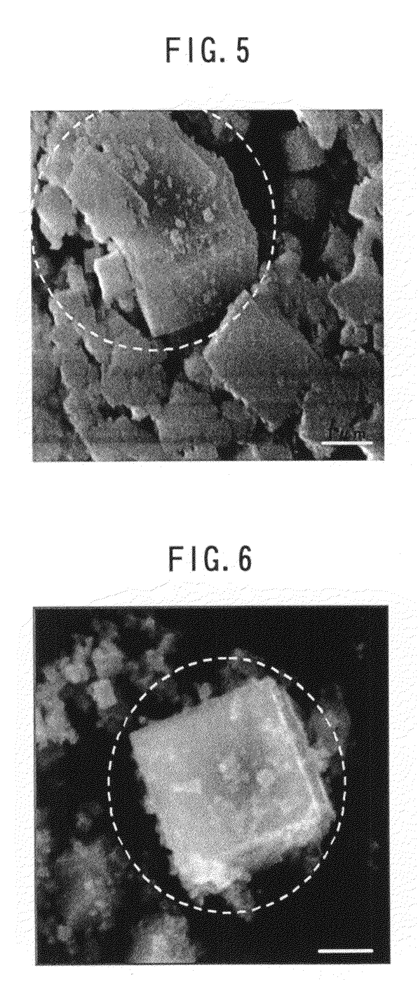

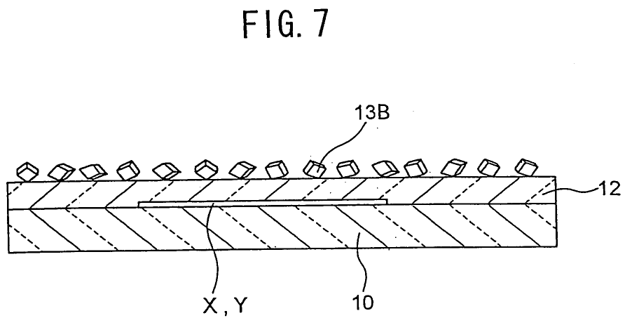

Here, magnesium oxide crystals forming the magnesium oxide layer 13 contain monocrystals obtained by vapor phase oxidation of magnesium steam that is generated by heating magnesium, such as vapor phase magnesium oxide crystals that are excited by irradiating electron beams to do CL light emission having a peak within a wavelength range of 200 to 300 nm (particularly, near 235 nm within 230 to 250 nm). The vapor phase magnesium oxide crystals contain a magnesium monocrystal having a particle diameter of 2000 angstrom or greater with a polycrystal structure in which cubic crystals are fit into each other in a SEM photo image as shown in FIG. 5, or with a cubic monocrystal structure in a SEM photo image as shown in FIG. 6. The magnesium monocrystal has features of higher purity, finer particles and less particle coagulation than magnesium oxides generated by other methods, which contributes to improved discharge properties in discharge delay, etc. In addition, in the embodiment, the vapor phase magnesium oxide monocrystals, which are used, have an average particle diameter of 500 angstrom or greater measured by the BET method, preferably 2000 angstrom or greater. Then, as shown in FIG. 7, the magnesium oxide monocrystals are attached to the surface of the dielectric layer 12 by spraying or electrostatic coating to form the magnesium oxide layer 13. Moreover, the magnesium oxide layer 13 may be formed in which a thin magnesium oxide layer is formed on the surface of the dielectric layer 12 and the increased dielectric layer 12A by vapor deposition or sputtering and vapor phase magnesium oxide monocrystals are attached thereon.

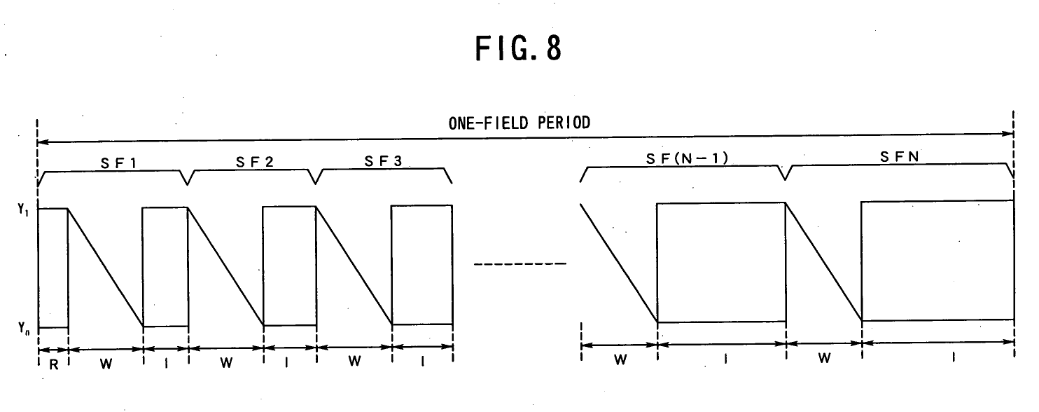

The drive control circuit 56 supplies various control signals that drive the PDP 50 having the structure in accordance with the light emission driving sequence adopting a subfield method (subframe method) as shown in FIG. 8 to the X-row electrode drive circuit 51, the Y-row electrode drive circuit 53, and the column electrode drive circuit 55. The X-row electrode drive circuit 51, the Y-row electrode drive circuit 53, and the column electrode drive circuit 55 generate various drive pulses to be supplied to the PDP 50 in accordance with the light emission driving sequence as shown in FIG. 8 and supply them to the PDP 50.

The load level detection circuit 57 detects the number of display cells PC that are set to an ON cell state in each subfield in accordance with a video signal, and uses it as a load level detected. As will be described later, each of the display cells PC is set to either one of an ON cell state and an OFF cell state in accordance with the video signal in an address stage W of each subfield. In display cells set to the ON cell state, wall charges remain. In display cells set to the OFF cell state, the wall charges are erased. In a sustain stage, display cells PC which are in the ON cell state alone generate sustain discharge for light emission. Data on the load level detected by the load level detection circuit 57 is supplied to the drive control circuit 56, and the timing (point of time) of clamping to a maximum potential V_{S} on leading is controlled in accordance with the load level in order to adjust the lengths of leading periods (front-edge periods) of positive sustain pulses IP_{X} and IP_{Y} which are generated in the sustain stage. The greater the load level, the later the point of time for the potential V_{S} to be reached is. The control on the leading periods of these sustain pulses will be described later.

In the light emission driving sequence shown in FIG. 8, a display period for one field (one frame) has subfields SF1 to SF12, and the address stage W and the sustain stage I are implemented in each of the subfields SF1 to SF12. Furthermore, only in the starting subfield SF1, a rest stage R is implemented prior to the address stage W. The period of the sustain stage I for the subfields SF1 to SF12 is prolonged in order of SF1 to SF12. Moreover, the period where the address stage W is implemented is an address period, and the period where the sustain stage I is implemented is a sustain period.

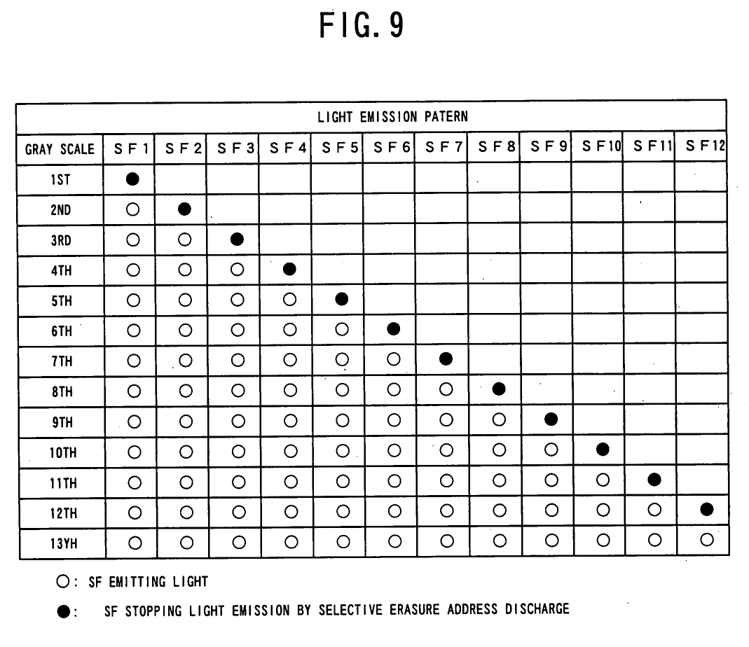

FIG. 9 depicts a diagram illustrating all the patterns of light emission addressing implemented based on the light emission driving sequence as shown in FIG. 8. 13 gray scales are formed by the light emission driving sequence of the subfields SF1 to SF12. As shown in FIG. 9, in the address stage W in one subfield in the subfields SF1 to SF12, selective erasure discharge is implemented for each of the display cells for each of the gray scales (depicted by a black circle). More specifically, wall electric charge formed in all the display cells of the PDP 50 by implementing the reset stage R remains until the selective erasure discharge is implemented, and prompts discharge and light emission in the sustain stage I in each subfield SF that is included during that remaining period (depicted by a white circle). Each of the display cells becomes a light emission state while the selective erasure discharge is being done for one field period, and 13 gray scales can be obtained by the length of the light emission state.

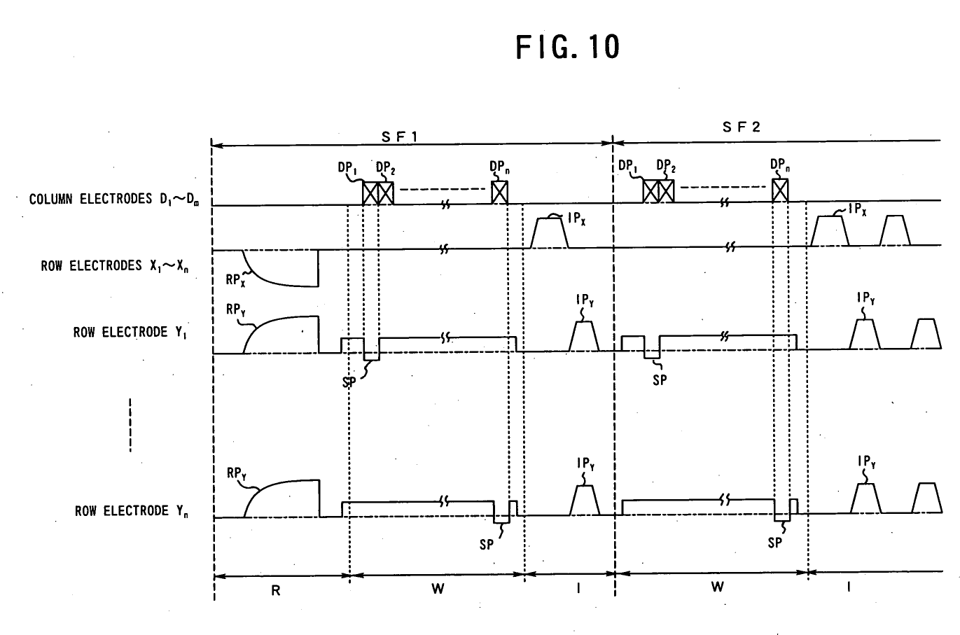

FIG. 10 depicts a diagram illustrating the application timing of various drive pulses to be applied to the column electrodes D, and the row electrodes X and Y of the PDP 50, extracting SF1 and SF2 from the subfields SF1 to SF12.

In the reset stage R implemented prior to the address stage W only in the starting subfield SF1, the X-row electrode drive circuit 51 simultaneously applies a negative reset pulse RP_{X} to the row electrodes X₁ to Xₙ as shown in FIG. 10. The reset pulse RP_{X} has a pulse waveform that the voltage value is slowly increased to reach a peak voltage value over time. Furthermore, at the same time when the application of the reset pulse RP_{X}, the Y-row electrode drive circuit 53 simultaneously applies to the row electrodes Y₁ to Yₙ a positive reset pulse RP_{Y} having a waveform that the voltage value is slowly increased to reach a peak voltage value over time as similar to the reset pulse RP_{X} as shown in FIG. 10. By the simultaneous application of the reset pulse RP_{X} and the reset pulse RP_{Y}, reset discharge is generated between the row electrodes X and Y in each of all the display cells PC_{1,1} to PC_{n,m}. After the reset discharge is terminated, a predetermined amount of wall electric charge is formed on the surface of the magnesium oxide layer 13 in the discharge space S in each of the display cells PC. More specifically, it is the state that a so-called wall electric charge is formed in which positive electric charge is formed near the row electrode X and negative electric charge is formed near the row electrode Y on the surface of the magnesium oxide layer 13.

In a panel on which the vapor phase magnesium oxide layer 13 is provided as a protective layer, since discharge probability is significantly high, weak reset discharge is stably generated. By combining a bump, particularly a T-shaped electrode in a broad tip end, reset discharge is localized near the discharge gap, and thus a possibility to generate sudden reset discharge such as discharge being generated in all the row electrodes is further suppressed. Therefore, discharge is hardly generated between the column electrode and the row electrode, and stable, weak reset discharge can be generated for a short time.

Furthermore, in the configuration that the vapor phase magnesium oxide layer 13 is provided, since the discharge probability is significantly improved, the application of a single reset pulse, that is, even a one-time reset discharge allows priming effect to be continued. Thus, the reset operation and the selective erasure operation can be further stabilized. Moreover, the number of times to do reset discharge is minimized to enhance contrast.

In addition, the effect of provision of the vapor phase magnesium oxide layer 13 will be described later.

Next, in the address stage W in each of the subfields SF1 to SF12, the Y-row electrode drive circuit 53 applies positive voltages to all the row electrodes Y₁ to Yₙ, and sequentially applies a scanning pulse SP having a negative voltage to each of the row electrodes Y₁ to Yₙ. While this is being done, the X-electrode drive circuit 51 changes the potentials of the electrodes X₁ to Xₙ to 0 V. The column electrode drive circuit 55 converts each data bit in a pixel drive data bit group DB1 corresponding to the subfield SF1 to a pixel data pulse DP having a pulse voltage corresponding to its logic level. For example, the column electrode drive circuit 55 converts the pixel drive data bit of a logic level of 0 to the pixel data pulse DP of a positive high voltage, while converts the pixel drive data bit of a logic level of 1 to the pixel data pulse DP of a low voltage (0 volt). Then, it applies the pixel data pulse DP to the column electrodes D₁ to Dₘ for each display line in synchronization with the application timing of a scanning pulse SP. More specifically, the column electrode drive circuit 55 first applies the pixel data pulse group DP1 formed of m pulses of the pixel data pulses DP corresponding to the first display line to the column electrodes D₁ to Dₘ, and then applies the pixel data pulse group DP2 formed of m pulses of the pixel data pulses DP corresponding to the second display line to the column electrodes D₁ to Dₘ. Between the column electrode D and the row electrode Y in the display cell PC to which the scanning pulse SP of the negative voltage and the pixel data pulse DP of the high voltage have been simultaneously applied, selective erasure discharge is generated to eliminate wall electric charge formed in the display cell PC. On the other hand, in the display cell PC to which the scanning pulse SP has been applied as well as the pixel data pulse DP of the low voltage (0 Volt), the selective erasure discharge as above is not generated. Therefore, the state to form wall electric charge is maintained in the display cell PC. More specifically, wall electric charge remains as it is when it exists in the display cell PC, whereas the state not to form wall electric charge is maintained when wall electric charge does not exist.

In this manner, in the address stage W based on the selective erasure addressing method, selective erasure addressing discharge is selectively generated in each of the display cells PC in accordance with each data bit in the pixel drive data bit group corresponding to the subfield, and then wall electric charge is removed. Thus, the display cell PC in which wall electric charge remains is set to the ON cell state, and the display cell PC in which wall electric charge is removed is set to the OFF cell state.

Subsequently, in the sustain stage I in each of the subfields, the X-row electrode drive circuit 51 and the Y-row electrode drive circuit 53 alternately, repeatedly apply positive sustain pulses IP_{X} and IP_{Y} to the row electrodes X₁ to Xₙ and Y₁ to Yₙ. The number of times to apply the sustain pulses IP_{X} and IP_{Y} depends on weighting luminance in each of the subfields. At each time that the sustain pulses IP_{X} and IP_{Y} are applied, only the display cells PC set to the ON cell state do sustain discharge, the cells in which a predetermined amount of wall electric charge is formed, and the fluorescent material layer 17 emits light in association with this discharge to form an image on the panel surface.

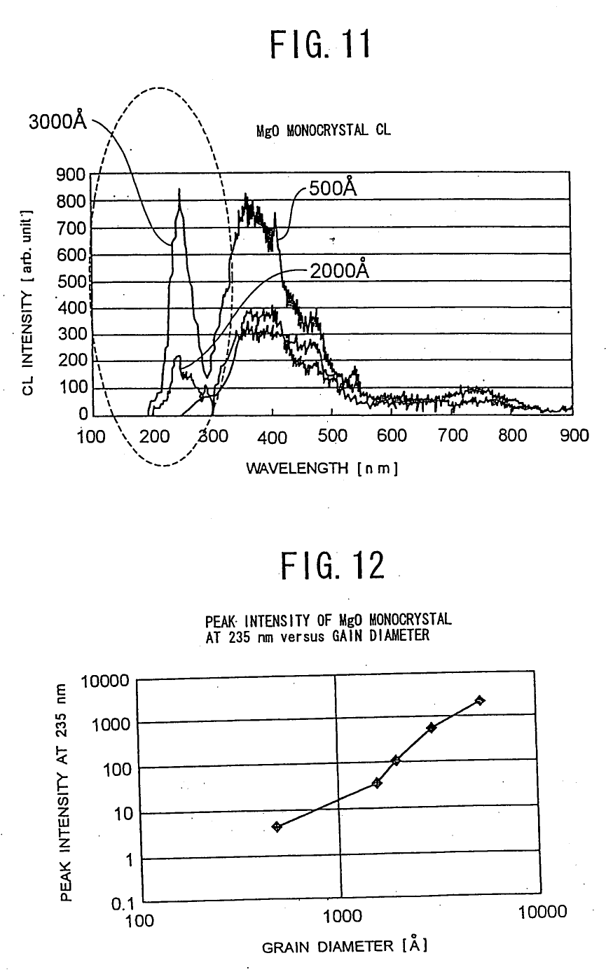

As described above, the vapor phase magnesium monocrystals contained in the magnesium oxide layer 13 formed in each of the display cells PC are excited by irradiating electron beams to do CL light emission having a peak within a wavelength range of 200 to 300 nm (particularly, near 235 nm within 230 to 250 nm) as shown in FIG. 11. As shown in FIG. 12, the greater the particle diameter of each of the vapor phase magnesium oxide crystals is, the greater the peak intensity of CL light emission is. More specifically, when magnesium is heated at temperature higher than usual in generating the vapor phase magnesium oxide crystals, vapor phase magnesium oxide monocrystals having the average particle diameter of 500 angstrom are formed as well as relatively large monocrystals having the particle diameter of 2000 angstrom or greater as shown in FIG. 5 or FIG. 6. Since temperature to heat magnesium is higher than usual, the length of flame generated by reacting magnesium with oxygen also becomes longer. Thus, the difference between a temperature of the flame and an ambient temperature becomes great, and therefore a group of vapor phase magnesium oxide monocrystals having a greater particle diameter particularly contain many monocrystals of high energy level corresponding to 200 to 300 nm (particularly near 235 nm).

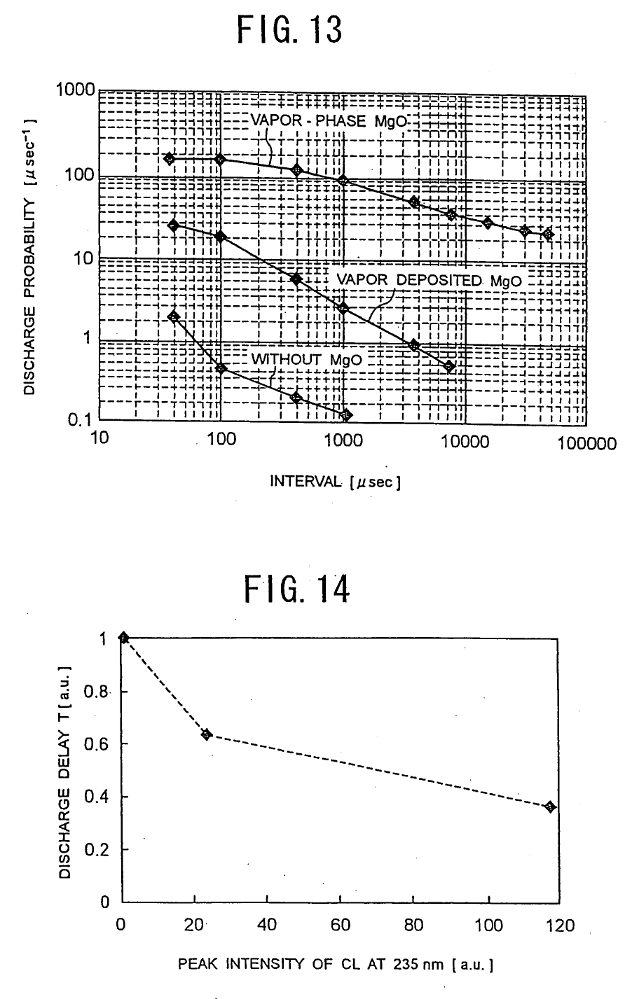

FIG. 13 is a diagram illustrating discharge probabilities: the discharge probability when no magnesium oxide layer was provided in the display cell PC; the discharge probability when the magnesium oxide layer is constructed by traditional vapor deposition; and the discharge probability when the magnesium oxide layer was provided which contained vapor phase magnesium oxide monocrystals to generate CL light emission having a peak at 200 to 300 nm (particularly near 235 nm within 230 to 250 nm) by irradiating electron beams. In addition, in FIG. 13, the horizontal axis is dwell time of discharge, that is, a time interval from discharge being generated to the next discharge being generated.

In this manner, when the magnesium oxide layer 13 is formed which contains the vapor phase magnesium oxide monocrystals that do CL light emission having a peak at 200 to 300 nm (particularly near 235 nm within 230 to 250 nm) by irradiating electron beams as shown in FIG. 5 or FIG. 6 in the discharge space S in each of the display cells PC, the discharge probability is higher than the case where the magnesium oxide layer is formed by traditional vapor deposition. In addition, as shown in FIG. 14, for the vapor phase magnesium oxide monocrystals described above, those of greater CL light emission intensity having a peak particularly at 235 nm in irradiating electron beams can shorten discharge delay generated in the discharge space S.

Therefore, even though voltage transition of the reset pulse to be applied to the row electrode is made smooth to weaken reset discharge as shown in FIG. 10 in order to suppress light emission in association with reset discharge that relates to no display image and to improve contrast, this weak reset discharge can be stabilized for a short time to be generated. Particularly, since each of the display cells PC adopts the structure in which local discharge is generated near the discharge gap between the T-shaped transparent electrodes Xa and Ya, a strong, sudden reset discharge that might be discharged in all the row electrodes can be suppressed as well as error discharge between the column electrode and the row electrode can be suppressed.

Furthermore, since the increased discharge probability (shortened discharge delay) allows a long, continuous priming effect by reset discharge in the reset stage R, address discharge generated in the address stage W and sustain discharge generated in the sustain stage I are high speed. Therefore, the pulse widths of the pixel data pulse DP and the scanning pulse SP to be applied to the column electrode D and the row electrode Y in order to generate address discharge as shown in FIG. 10 can be shortened. By that amount, processing time for the address stage W can be shortened. Moreover, the pulse width of the sustain pulse IP_{Y} to be applied to the row electrode Y in order to generate sustain discharge as shown in FIG. 10 can be shortened. By that amount, processing time for the sustain stage I can be shortened.

Accordingly, by the amount of the shortened processing time for each of the address stage W and the sustain stage I, the number of subfields to be provided in one field (or one frame) display period can be increased, and the number of gray scales can be intended to increase.

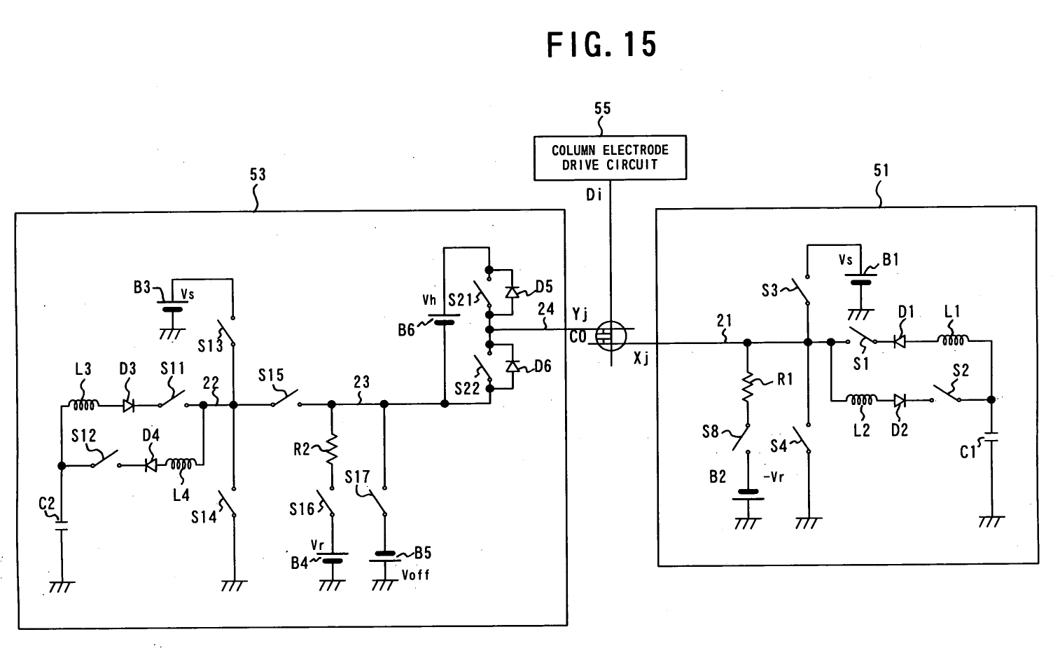

FIG. 15 depicts a specific configuration of the X-row electrode drive circuit 51 and the Y-row electrode drive circuit 53 on electrodes Xⱼ and Yⱼ. The electrode Xⱼ is the electrode at the jth line in electrodes X₁ to Xₙ, and the electrode Yⱼ is the electrode at the jth line in the electrodes Y₁ to Yₙ. The portion between the electrodes Xⱼ and Yⱼ serves as a capacitor CO.

In the X-row drive circuit 51, two power sources B1 and B2 are provided. The power source B1 outputs a voltage Vₛ (for example, 170 V), and the power source B2 outputs a voltage Vᵣ (for example, 190 V). A positive terminal of the power source B1 is connected to a connection line 21 for the electrode Xⱼ through a switching element S3, and a negative terminal thereof is grounded. Between the connection line 21 and the ground, a switching element S4 is connected, as well as a series circuit formed of a switching element S1, a diode D1 and a coil L1, and a series circuit formed of a coil L2, a diode D2 and a switching element S2 are connected to the ground side commonly through a capacitor C1. In addition, the diode D1 has an anode on the capacitor C1 side, and the diode D2 is connected as the capacitor C1 side is a cathode. Furthermore, a negative terminal of the power source B2 is connected to the connection line 21 through a switching element S8 and a resistor R1, and a positive terminal of the power source B2 is grounded.

In the Y-row electrode drive circuit 53, four power sources B3 to B6 are provided. The power source B3 outputs a voltage Vₛ (for example, 170 V), the power source B4 outputs a voltage Vᵣ (for example, 190 V), the power source B5 outputs a voltage V_{off} (for example, 140 V), and the power source B6 outputs a voltage vₕ (for example, 160 V, vₕ>V_{off}). A positive terminal of the power source B3 is connected to a connection line 22 for a switching element S15 through a switching element S13, and a negative terminal thereof is grounded. Between the connection line 22 and the ground, a switching element S14 is connected as well as a series circuit formed of a switching element S11, a diode D3 and a coil L3, and a series circuit formed of a coil L4, a diode D4 and a switching element S12 are connected to the ground side commonly through a capacitor C2. In addition, the diode D3 has an anode on the capacitor C2 side, and the diode D4 is connected as the capacitor C2 side is a cathode.

The connection line 22 is connected to a connection line 23 for a negative terminal of the power source B6 through the switching element S15. A negative terminal of the power source B4 and a positive terminal of the power source B5 are grounded. A positive terminal of the power source B4 is connected to the connection line 23 through a switching element S16 and a resistor R2, and a negative terminal of the power source B5 is connected to the connection line 23 through a switching element S17.

A positive terminal of the power source B6 is connected to a connection line 24 for the electrode Yⱼ through a switching element S21, and the negative terminal of the power source B6 connected to the connection line 23 is connected to the connection line 24 through a switching element S22. The diode D5 is connected in parallel to the switching element S21, and the diode D6 is connected in parallel to the switching element S22. The diode D5 has an anode on the connection line 24 side, and the diode D6 is connected as the connection line 24 side is a cathode.

The drive control circuit 56 controls turning on and off the switching elements S1 to S4, S8, S11 to S17, S21 and S22.

In the X-row electrode drive circuit 51, the resistor R1, the switching elements S8 and the power source B2 configure a resetting portion, and the remaining elements configure a sustaining portion. In addition, in the Y-row electrode drive circuit 53, the power source B3, the switching elements S11 to S15, the coils L3 and L4, the diodes D3 and D4, and the capacitor C2 configure a sustaining portion, the power source B4, the resistor R2, and the switching element S16 configure a resetting portion, and the remaining power sources B5 and B6, the switching elements S13, S17, S21, S22, and the diodes D5 and D6 configure an addressing portion.

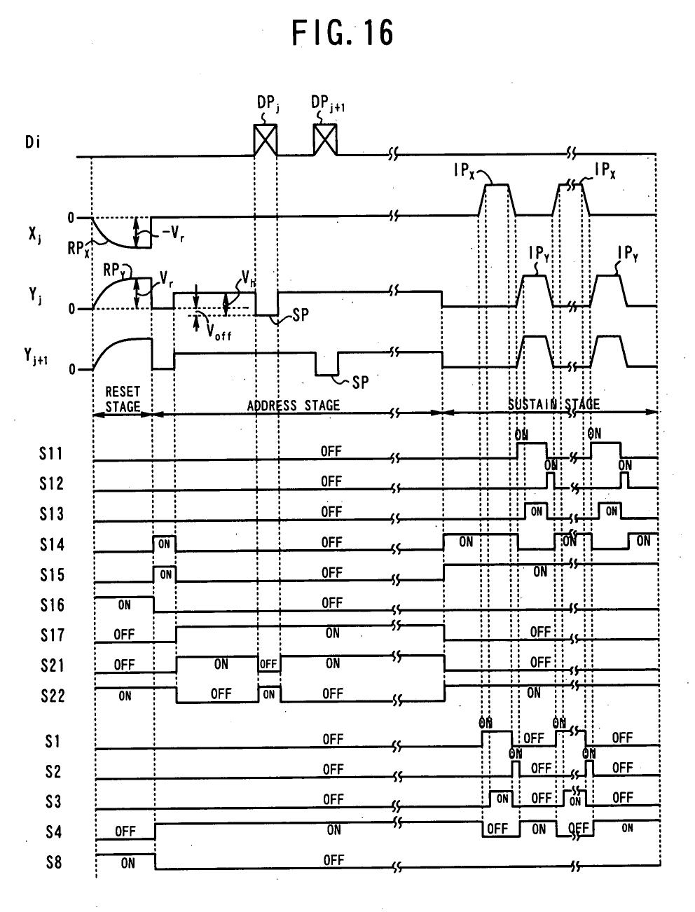

Next, the operations of the X-row electrode drive circuit 51 and the Y-row electrode drive circuit 53 in this configuration will be described with reference to a time chart shown in FIG. 16.

First, in the reset stage, the switching element S8 of the X-row electrode drive circuit 51 is turned on, and the switching elements S16 and S22 of the Y-row electrode drive circuit 53 are both turned on. The other switching elements are off. Turning on the switching elements S16 and S22 carries current from the positive terminal of the power source B4 to the electrode Yⱼ through the switching element S16, the resistor R2 and the switching element S22, and turning on the switching element S8 carries current from the electrode Xⱼ through the resistor R1, and the switching element S8 to the negative terminal of the power source B2. The potential of the electrode Xⱼ is gradually decreased by the time constant of the capacitor CO and the resistor R1, and is the reset pulse RP_{X}, whereas the potential of the electrode Yⱼ is gradually increased by the time constant of the capacitor CO and the resistor R2, and is the reset pulse PR_{Y}. The reset pulse RP_{X} finally becomes a voltage −Vᵣ, and the reset pulse PR_{Y} finally becomes a voltage Vᵣ. The reset pulse RP_{X} is applied to all the electrodes X₁ to Xₙ at the same time, and the reset pulse PR_{Y} is generated for each of the electrodes Y₁ to Yₙ and is applied to all the electrodes Y₁ to Yₙ.

The simultaneous application of the reset pulses RP_{X} and RP_{Y}, all the display cells of the PDP 50 are discharge excited to generate charged particles, and after terminating the discharge, a predetermined amount of wall electric charge is evenly formed on the dielectric layer of all the display cells.

After the levels of the reset pulses RP_{X} and RP_{Y} are saturated, the switching elements S8 and S16 are turned off before the reset stage is ended. Furthermore, the switching elements S4, S14 and S15 are turned on at this time, and the electrodes Xⱼ and Yⱼ are both grounded. Thus, the reset pulses RP_{X} and RP_{Y} disappear.

Subsequently, when the address stage W is started, the switching elements S14, S15 and S22 are turned off, the switching element S17 is turned on, and the switching element S21 is turned on at the same time. Thus, since the power source B6 is serially connected to the power source B5, the potential of the positive terminal of the power source B6 is Vₕ−V_{off}. The positive potential is applied to the electrode Yⱼ through the switching element S21.

In the address stage W, the column electrode drive circuit 55 converts pixel data for each pixel based on the video signal to the pixel data pulses DP₁ to DPₙ having a voltage value corresponding to its logic level, and sequentially applies them to the column electrodes D₁ to Dₘ for each one display line. As shown in FIG. 16, the pixel data pulses DPⱼ, DPⱼ₊₁ with respect to the electrodes Yⱼ, Yⱼ₊₁ are applied to the column electrode Dᵢ.

The Y-row electrode drive circuit 53 sequentially applies the scanning pulse SP of the negative voltage to the row electrodes Y₁ to Yₙ in synchronization with the timing of each of the pixel data pulse groups DP₁ to DPₙ.

In synchronization with the application of the pixel data pulse DPⱼ from the column electrode drive circuit 55, the switching element S21 is turned off, and the switching element S22 is tuned on. Thus, the negative potential −V_{off} of the negative terminal of the power source B5 is applied to the electrode Yⱼ as the scanning pulse SP through the switching element S17 and the switching element S22. Then, in synchronization with the stop of the application of the pixel data pulse DPⱼ from the column electrode drive circuit 55, the switching element S21 is turned on, the switching element S22 is turned off, and the potential Vₕ−V_{off} of the positive terminal of the power source B6 is applied to the electrode Yⱼ through the switching element S21. After that, as shown in FIG. 16, the scanning pulse SP is applied to the electrode Yⱼ₊₁ as similar to the electrode Yⱼ in synchronization with the application of the pixel data pulse DPⱼ₊₁ from the column electrode drive circuit 55.

In the display cells belonging to the row electrode to which the scanning pulse SP has been applied, discharge is generated in the display cell to which the pixel data pulse of the positive voltage has been further applied at the same time, and most of its wall electric charge are lost. On the other hand, since discharge is not generated in the display cell to which the scanning pulse SP has been applied but the pixel data pulse of the positive voltage has not been applied, the wall electric charge still remains. The display cell in which the wall electric charge remains is in the ON cell state, and the display cell in which the wall electric charge has disappeared is in the OFF cell state.

In switching from the address stage W to the sustain stage I, the switching elements S17 and S21 are turned off, and the switching elements S14, S15 and S22 are instead turned on. The ON-state of the switching element S4 continues.

In the sustain stage I, in the X-row electrode drive circuit 51, turning on the switching element S4 turns the potential of the electrode Xⱼ to nearly 0 V of the ground potential (first potential). Subsequently, when the switching element S4 is turned off and the switching element S1 is turned on, current reaches the electrode Xⱼ through the coil L1, the diode D1, and the switching element S1 by electric charge charged in the capacitor C1 to flow into the capacitor CO, and then the capacitor CO is charged. At this time, the time constant of the coil L1 and the capacitor CO gradually increases the potential of the electrode Xⱼ as shown in FIG. 16, thus effecting a resonant transition.

Then, the switching element S3 is turned on. Thus, the potential Vₛ (second potential) of the positive terminal of the power source B1 is applied to the electrode Xⱼ, and the potential of the electrode Xⱼ is clamped to Vₛ.

After that, the switching elements S1 and S3 are turned off, the switching element S2 is turned on, and current is carried from the electrode Xⱼ into the capacitor C1 through the coil L2, the diode D2, and the switching element S2 by electric charge charged in the capacitor CO. At this time, the time constant of the coil L2 and the capacitor C1 gradually decreases the potential of the electrode Xⱼ as shown in FIG. 16, thus effecting a resonant transition. When the potential of the electrode Xⱼ reaches nearly 0V, the switching element S2 is turned off, and the switching element S4 is turned on.

In the X-row electrode drive circuit 51, the period from the time when the switching element S1 is turned on to right before the switching element S3 is turned on is a period for the first step. The ON-period of the switching element S3 is a period for the second step. The ON-period for the switching element S2 is a period for the third step. The ON-period for the switching element S4 is a period for the fourth step.

By this operation, the X-row electrode drive circuit 51 applies the sustain pulse IP_{X} of the positive voltage to the electrode Xⱼ as shown in FIG. 16.

In the Y-row electrode drive circuit 53, at the same time when turning on the switching element S4 where the sustain pulse IP_{X} goes out, the switching element S11 is turned on, and the switching element S14 is turned off. The potential of the electrode Yⱼ is the ground potential of nearly 0 V when the switching element S14 is on. However, when the switching element S14 is turned off and the switching element S11 is turned on, current reaches the electrode Yⱼ through the coil L3, the diode D3, the switching element S11, the switching element S15, and the diode D6 by electric charge charged in the capacitor C2 to flow into the capacitor CO, and then the capacitor CO is charged. At this time, the time constant of the coil L3 and the capacitor CO gradually increases the potential of the electrode Yⱼ as shown in FIG. 16.

Subsequently, the switching element S13 is turned on. Thus, the potential Vₛ of the positive terminal of the power source B3 is applied to the electrode Yⱼ through the switching element S13, the switching element S15, and the diode D6.

After that, the switching elements S11 and S13 are turned off, the switching element S12 is turned on, the switching element S22 is turned on, and current flows from the electrode Yⱼ into the capacitor C2 through the switching element S22, the switching element S15, the coil L4, the diode D4, and the switching element S12 by electric charge charged in the capacitor CO. At this time, the time constant of the coil L4 and the capacitor C2 gradually decreases the potential of the electrode Yⱼ as shown in FIG. 16. When the potential of the electrode Yⱼ reaches nearly 0 V, the switching elements S12 and S22 are turned off, and the switching element S14 is turned on.

Also in the Y-row electrode drive circuit 53, it is a period for the first step from the time when turning on the switching element S11 to right before turning on the switching element S13. The ON-period of the switching element S13 is a period for the second step. The ON-period of the switching element S12 is a period for the third step. The ON-period of the switching element S14 is a period for the fourth step.

By this operation, the Y-row electrode drive circuit 53 applies the sustain pulse IP_{Y} of the positive voltage to the electrode Yⱼ as shown in FIG. 16.

In this manner, in the sustain stage I, since the sustain pulse IP_{X} and the sustain pulse IP_{Y} are alternately generated and alternately applied to the electrodes X₁ to Xₙ and the electrodes Y₁ to Yₙ, the display cell in which the wall electric charge still remains repeats discharge light emission to maintain the ON cell state.

The leading periods of the respective sustain pulses IP_{X} and IP_{Y} are periods for changing from the ground potential to the potential V_{S} as described above. The lengths of the periods are controlled in accordance with the load level detected by the load level detection circuit 57. The greater the load level is, the longer the leading periods of the respective sustain pulses IP_{X} and IP_{Y} are.

Next, description will be given of the case of generating two types of sustain pulses having different lengths of leading periods in accordance with the load level for the sake of generating the sustain pulses IP_{X} and IP_{Y}.

If the load level detected by the load level detection circuit 57 is greater than or equal to a threshold, the drive control circuit 56 makes the X-row electrode driving circuit 51 and the Y-row electrode driving circuit 53 generate a first sustain pulse having a long leading period. It makes the X-row electrode driving circuit 51 and the Y-row electrode driving circuit 53 generate a second sustain pulses having a leading period shorter than that of the first sustain pulses if the load level is smaller than the threshold.

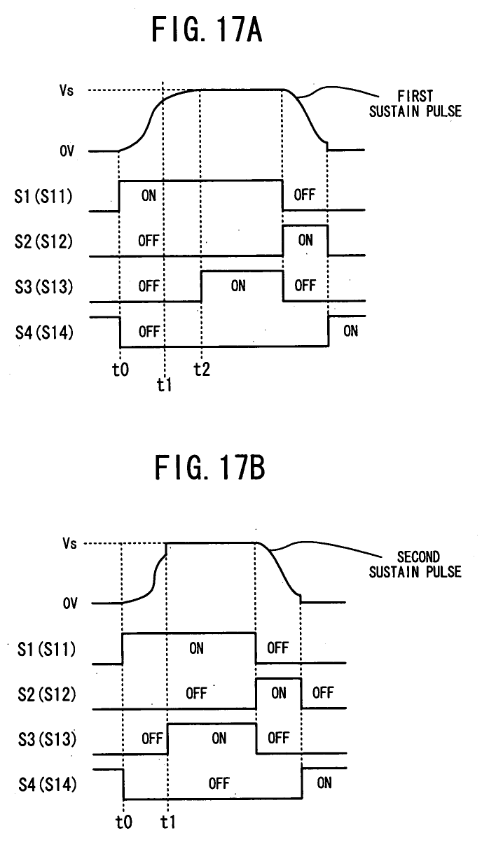

For the first sustain pulse, as shown in FIG. 17A, the switching element S1 (S11) is turned on and the switching element S4 (S14) is turned off at a time t0, and the switching element S3 (S13) is turned on at a time t2. For the second sustain pulse, on the other hand, the switching element S3 (S13) is turned on at a time t1, or before the time t2, as shown in FIG. 17B. As a result, the second sustain pulse is clamped to the potential V_{S} at the time t1. That is, it is clamped to the potential V_{S} before reaching the potential V_{S} through a resonant action. The first sustain pulse is clamped to the potential V_{S} after a delay from the time t1, or at the time t2. The time t2 is a time point that comes after the sustain pulses IP_{X} and IP_{Y} reach the potential V_{S} through a resonant action. In this way, the leading period of the first sustain pulse is set to be longer than the leading period of the second sustain pulse. It should be appreciated that S1 to S4 in FIGS. 17A and 17B correspond to switching elements for generating the sustain pulse IP_{X}, and S11 to S14 correspond to switching elements for generating sustain pulse IP_{Y}.

Accordingly, the timing of clamping to the potential V_{S} of the sustain pulses IP_{X} and IP_{Y} to be generated when the load level is greater than or equal to the threshold is delayed behind the timing of clamping of the sustain pulses IP_{X} and IP_{Y} to be generated when the load level is smaller than the threshold. This makes it possible to create some variation in the timing of sustain discharge in each pixel even if a large number of display cells make sustain discharge. That is, when a large number of display cells make sustain discharge at the same time point, the sustain pulses could be deformed greatly in waveform with decrease in discharge intensity. However, like the foregoing first sustain pulse, the pulse leading period can be increased to prevent the display cells from discharging all at once, so that discharge in each display cell can occur with some variation. This can prevent sustain pulses from being deformed in waveform and suppress decrease in the discharge intensity of each display cell when a large number of display cells generate sustain discharge. Thus, luminance variation of the display panel can be improved.

The drive control circuit 56 may increase the leading periods of the sustain pulses IP_{X} and IP_{Y} as the load level detected by the load level detection circuit 57 increases. That is, the drive control circuit 56 creates a data table showing the load levels and the points of clamping to the potential V_{S} in a memory in advance, reads a clamping point corresponding to the load level detected by the load level detection circuit 57 from the memory subfield by subfield, and performs clamping of each of the sustain pulses IP_{X} and IP_{Y}.

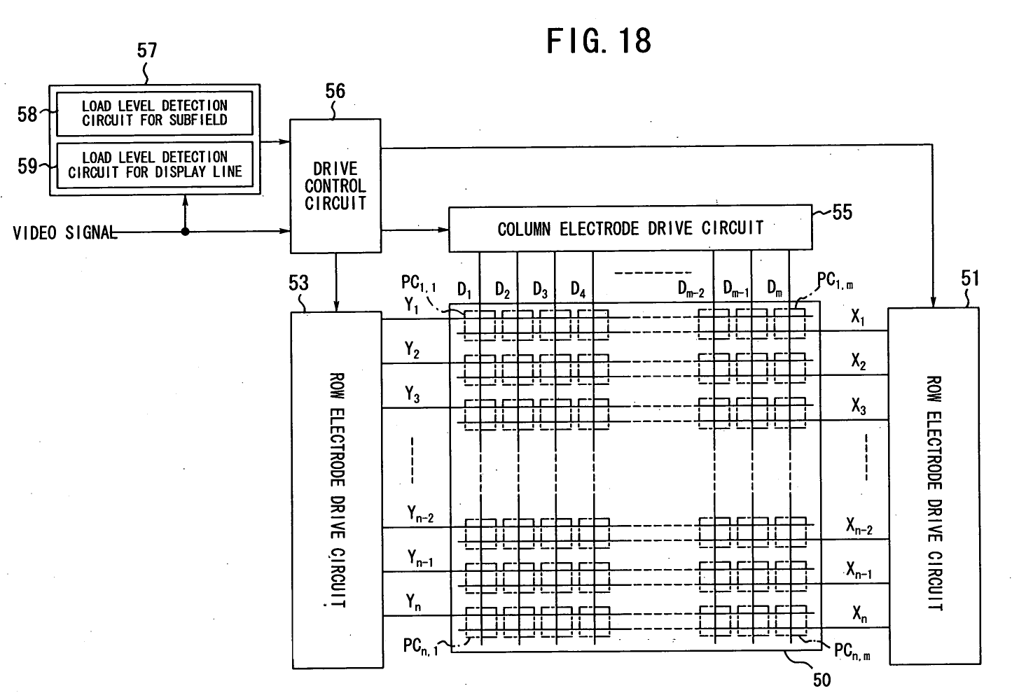

FIG. 18 shows an embodiment of the invention of the present application. In the plasma display apparatus shown in FIG. 18, the load level detection circuit 57 comprises a load level detection unit 58 for detecting a load level for each subfield and a load level detection unit 59 for detecting a load level for each display line. The load level for each subfield detected by the load level detection unit 58 and the load level for each display line detected by the load level detection unit 59 are supplied to the drive control circuit 56 as data. The drive control circuit 56 sets the point of clamping to the potential V_{S} of each of the sustain pulses IP_{X} and IP_{Y} to be applied in each subfield in accordance with the load level of each subfield and the load level of each display line detected, thereby controlling the length of leading period (front-edge period) thereof. Even if each subfield has the same load level, the length of the leading period of each of the sustain pulses is controlled in consideration of a load distribution based on the load levels of respective display lines. Consequently, if the load levels in respective subfields are the same level but with a load distribution that can easily cause luminance variation, the leading periods of the sustain pulses are increased for appropriate discharge intensities. Thus, the luminance variation can be further improved.

In addition, for the PDP 50 in the embodiments, the structure is adopted in which the display cell PC is formed between the row electrodes X and the row electrodes Y that are paired with each other as (X₁, Y₁), (X₂, Y₂), (X₃, Y₃), . . . , (Xₙ, Yₙ). However, the structure may be adopted in which the display cell PC is formed between all the row electrodes. More specifically, the structure may be adopted in which the display cell PC is formed between the row electrodes X₁ and Y₁, the row electrode Y₁ and X₂, the row electrode X₂ and Y₂, . . . , the row electrode Yₙ₋₁ and Xₙ, the row electrode Xₙ and Yₙ.

Furthermore, for the PDP 50 in the embodiments, the structure is adopted in which the row electrodes X and Y are formed in the front transparent substrate 10 and the column electrode D and the fluorescent material layer 17 are formed in the rear substrate 14. However, the structure may be adopted in which the column electrodes D as well as the row electrodes X and Y are formed in the front transparent substrate 10 and the fluorescent material layer 17 is formed in the rear substrate 14.

Moreover, in the foregoing embodiments, the rising periods are subjected to the length adjustment as the front-edge periods since the positive sustain pulses IP_{X} and IP_{Y} are generated. If negative sustain pulses are generated, their falling periods will be subjected to the length adjustment as the front-edge periods.

As above, according to the present invention, the leading periods of the sustain pulses to be applied in each subfield are increased in length as the load level in each subfield increases. This creates some variations in the timings of sustain discharge in respective display cells even if a large number of display cells generate sustain discharge. It is therefore possible to prevent sustain pulses from being deformed greatly in waveform and suppress decrease in the discharge intensity of each display cell. Therefore, since luminance variation is improved, display quality can be enhanced.

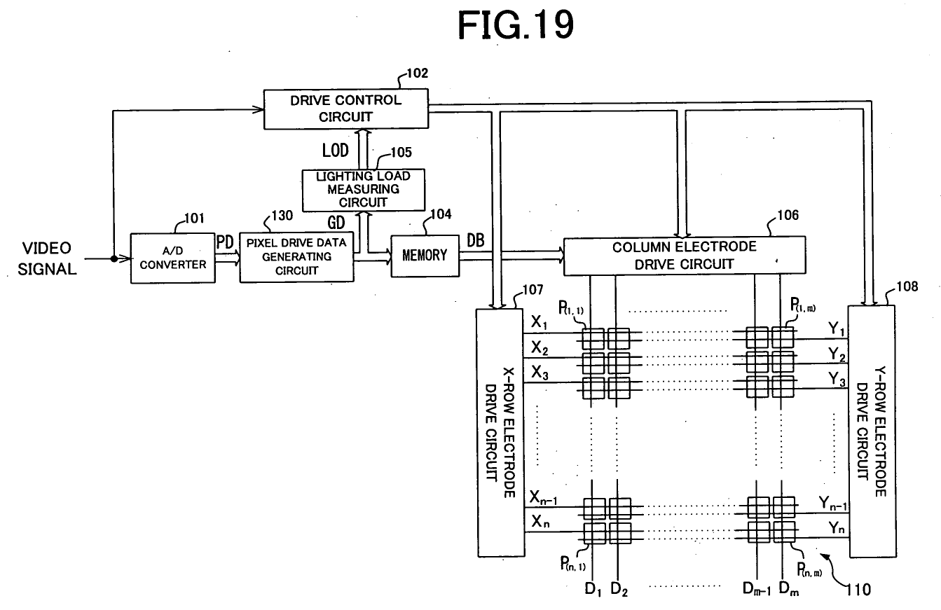

FIG. 19 is a diagram showing the schematic configuration of a plasma display apparatus which drives a plasma display panel by using the driving method according to the present invention.

The plasma display apparatus includes an A/D converter 101, a drive control circuit 102, a memory 104, a lighting load measuring circuit 105, a column electrode drive circuit 106, an X-row electrode drive circuit 107, a Y-row electrode drive circuit 108, and a pixel drive data generating circuit 130 as well as the plasma display panel or PDP 110.

In FIG. 19, the PDP 110 has a front transparent substrate and a rear substrate (not shown) which are opposed and arranged to sandwich a discharge space filled with a discharge gas. Row electrodes X₁ to Xₙ and row electrodes Y₁ to Yₙ, each being arranged to extend in a lateral direction (horizontal direction) of the two-dimensional screen, are formed on the front transparent substrate. These row electrodes X₁ to Xₙ and Y₁ to Yₙ are paired into respective pairs of row electrodes Xᵢ and Yᵢ (i: 1 to n) which are the first to nth display lines of the PDP 110. Column electrodes D1 to Dm, each being arranged to extend in a vertical direction (perpendicular direction) of the two-dimensional display screen, are formed on the rear substrate so as to intersect each of the row electrodes X₁ to Xₙ and the row electrodes Y₁ to Yₙ. Display cells P, or capacitive light-emitting devices, are formed at the intersections of each of the pairs of row electrodes (X, Y) including the foregoing discharge space and the column electrodes D. That is, the PDP 110 has a matrix array of (n, m) display cells P, consisting of the first-row first-column display cell P_{(1,1)} to the nth-row mth-column display cell P_{(n,m)}.

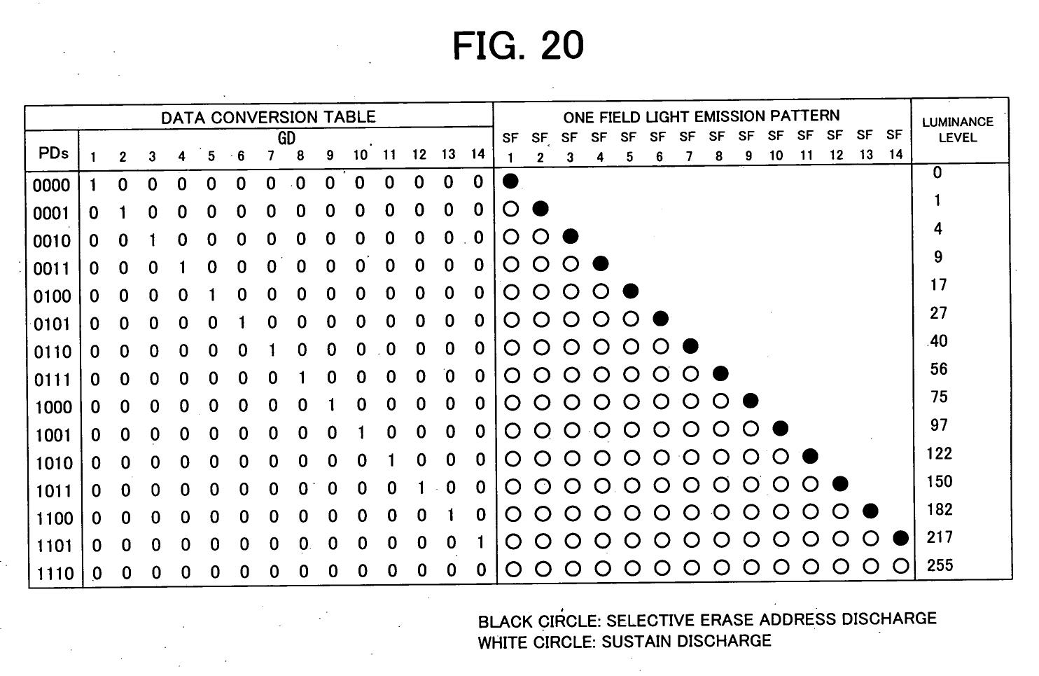

The A/D converter 101 converts an input video signal into, for example, 8-bit pixel data PD which expresses its brightness levels in 256 tone levels pixel by pixel. The pixel drive data generating circuit 130 initially applies multi-gradation processing consisting of error diffusion processing and dither processing to the pixel data PD, thereby converting it into 4-bit multi-gradation pixel data PDₛ. More specifically, by such multi-gradation processing, it obtains multi-gradation pixel data PDₛ which has an increased number of brightness levels to be visualized when a plurality of adjoining pixels are viewed as one single pixel unit. Next, the pixel drive data generating circuit 130 converts this multi-gradation pixel data PDₛ into 14-bit pixel drive data GD in accordance with a data conversion table as shown in FIG. 20. It should be noted that the first to fourteenth bits of the pixel drive data GD correspond to subfields SF1 to SF14 (to be described later), respectively. The pixel drive data generating circuit 130 supplies the 14-bit pixel drive data GD on each pixel to the memory 104 and the lighting load measuring circuit 105.

For each of the subfields SF1 to SF14, the lighting load measuring circuit 105 determines the total number of display cells that are in a lighting mode, which corresponds to the ON cell state, at a sustain stage I in accordance with the pixel drive data GD. That is, it determines the number of display cells P that are in the lighting mode of all the display cells P_{(1,1)} to P_{(n,m)} of the PDP 110 subfield by subfield. The lighting load measuring circuit 105 then supplies the total numbers of display cells in the lighting mode determined in the respective subfields to the drive control circuit 102 as lighting load level signals LOD₁ to LOD₁₄ which indicate the amounts of load of the subfields SF1 to SF14 at lighting time, respectively.

The memory 104 writes the foregoing pixel drive data GD in succession. When it finishes writing (n,m) pieces of pixel drive data GD_{(1,1)} to GD_{(n,m)} for a single screen, corresponding to the respective first-row first-column to nth-row nth-column pixels, the memory 104 performs a read operation as follows.

Initially, considering the first bits of the respective pieces of pixel drive data GD_{(1,1)} to GD_{(n,m)} as pixel drive data bits DB1_{(1,1)} to DB1_{(n,m)}, the memory 104 reads these in units of a single display line and supplies the same to the column electrode drive circuit 106 in the subfield SF1 to be described. Next, considering the second bits of the respective pieces of pixel drive data GD_{(1,1)} to GD_{(n,m)} as pixel drive data bits DB2_{(1,1)} to DB2_{(n,m)}, the memory 104 reads these in units of a single display line and supplies the same to the column electrode drive circuit 106 in the subfield SF2 to be described. Next, considering the third bits of the respective pieces of pixel drive data GD_{(1,1)} to GD_{(n,m)} as pixel drive data bits DB3_{(1,1)} to DB3_{(n,m)}, the memory 104 reads these in units of a single display line and supplies the same to the column electrode drive circuit 106 in the subfield SF3 to be described. Subsequently, considering the fourth to fourteenth bits of the respective pieces of pixel drive data GD_{(1,1)} to GD_{(n,m)} as pixel drive data bits DB_{(1,1)} to DB_{(n,m)}, the memory 104 similarly reads these in units of a single display line and supplies the same to the column electrode drive circuit 106 in the subfields SF corresponding to the respective pixel drive data bits DB.

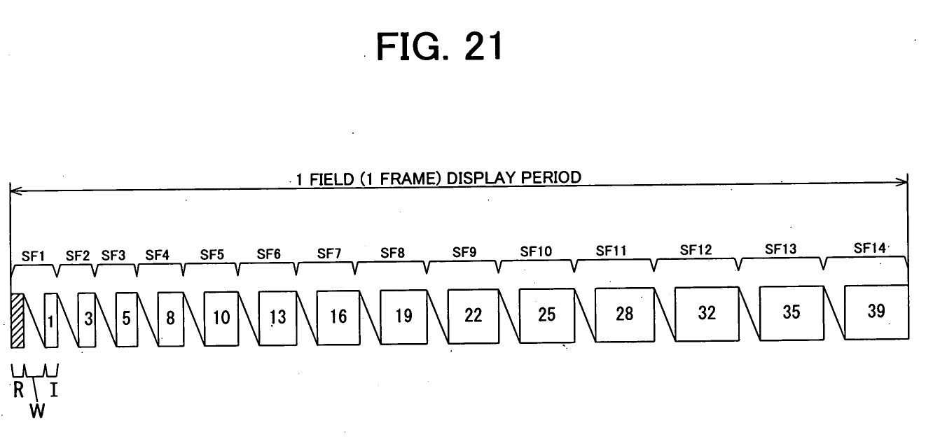

The drive control circuit 102 generates various types of control signals intended for driving the PDP 110 in accordance with a light emission driving sequence shown in FIG. 21, and supplies them to a panel driver which is composed of the column electrode drive circuit 106, X-row electrode drive circuit 107, and Y-row electrode drive circuit 108. That is, in each of such subfields SF1 to SF14 as shown in FIG. 21, the drive control circuit 102 supplies the panel driver with various control signals for exercising driving for each of an address stage W and a sustain stage I in succession. Note that only in the first subfield SF1, the drive control circuit 102 supplies the panel driver with various control signals for exercising driving for a reset stage R prior to the address stage W.

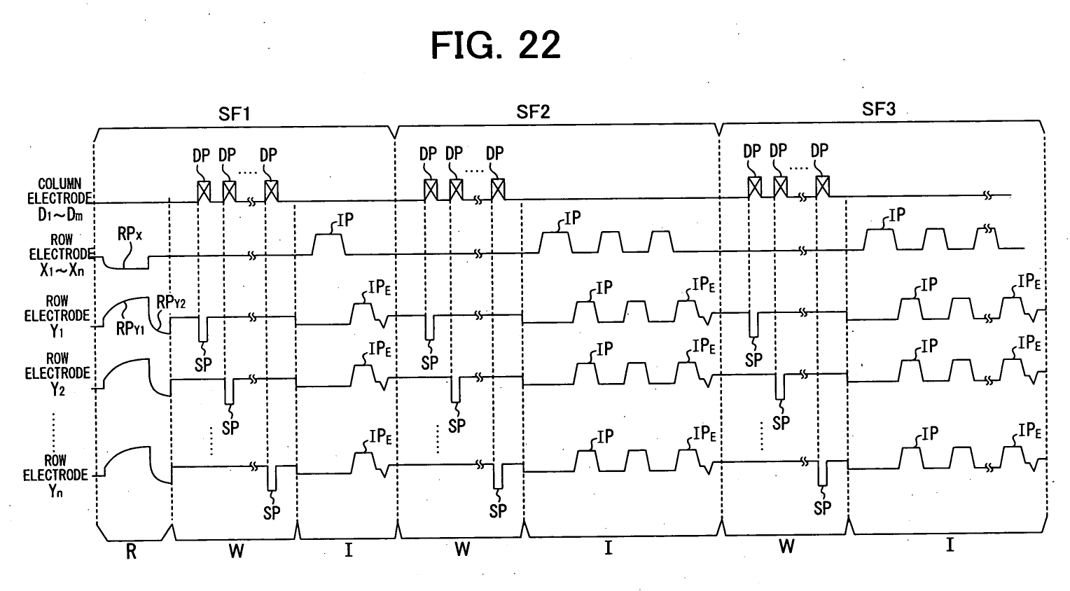

The panel driver, i.e., the column electrode drive circuit 106, the X-row electrode drive circuit 107, and the Y-row electrode drive circuit 108 generate various types of driving pulses as shown in FIG. 22 and supply the driving pulses to the column electrodes D and the row electrodes X and Y of the PDP 110 in accordance with the various control signals supplied from the drive control circuit 102.

In FIG. 22, at the reset stage R of the first subfield SF1, the X-row electrode drive circuit 107 applies a negative reset pulse RP_{X} as shown in FIG. 22 to all the row electrodes X₁ to Xₙ. In the meantime, the Y-row electrode drive circuit 108 applies, to all the row electrodes Y₁ to Yₙ, a positive reset pulse RP_{Y1} having a waveform such that a potential of the front edge slowly changes with a lapse of time as compared to sustain pulses to be described later. In response to the simultaneous application of these reset pulses RP_{X} and PR_{Y1}, first reset discharge occurs in all the display cells P so that wall charges remaining in any of the display cells P disappear. After the application of the reset pulse RP_{Y1}, the Y-row electrode drive circuit 108 successively applies to all the row electrodes Y₁ to Yₙ a negative reset pulse RP_{Y2} such that its front edge makes a slow potential change with a lapse of time as shown in FIG. 22. In response to the application of the reset pulse RP_{Y2}, second reset discharge occurs in all the display cells P so that a predetermined amount of wall charge is formed in each display cell P. That is, the execution of the reset stage R initializes all the display cells P into a lighting mode.

Next, at the address stage W of each of the subfields SF1 to SF14, the column electrode drive circuit 106 generates pixel data pulses having pulse voltages corresponding to the logic levels of respective pixel drive data bits DB for a one display line (m bits) which are supplied from the memory 104. For example, the column electrode drive circuit 106 generates a pixel data pulse of positive high voltage in response to a pixel drive data bit DB of logic level 1, and generates a pixel data pulse of low voltage (0 V) in response to a pixel drive data bit DB of logic level 0. The column electrode drive circuit 106 then applies these pixel data pulses to the column electrodes D₁ to Dₘ in units of a group of pixel data pulses DP for a single display line (m pulses) in succession.

Moreover, in the foregoing address stage W, the Y-row electrode drive circuit 108 generates a negative scan pulse SP as shown in FIG. 22 and applies the scan pulse SP to the row electrodes Y₁ to Yₙ in succession at the same timing as the timing of application of respective groups of pixel data pulses DP. Display cells P only at the intersections between the row electrode to which a scan pulse SP is applied and the column electrodes to which pixel data pulses of high voltage are applied generate discharge selectively (selective erase address discharge), whereby the wall charges remaining in those display cells P are erased. That is, the display cells P that lose their wall charges due to the generation of the selective erase address discharge are set into an extinction mode which corresponds to the OFF cell state. On the other hand, display cells P at the intersections between the row electrode to which the scan pulse SP is applied and the column electrodes to which pixel data pulses of low voltage are applied cause no selective erase address discharge. Consequently, these display cells P maintain their immediately preceding states (lighting mode or extinction mode).

That is, the execution of the address stage W sets the individual display cells P to either one of the lighting mode and the extinction mode depending on the respective pixel drive data bits DB corresponding to that subfield.

Next, at the sustain stage I of each of the subfields SF1 to SF14, the X-row electrode drive circuit 107 and the Y-row electrode drive circuit 108 apply positive sustain pulses IP to the row electrodes X₁ to X₁ and Y₁ to Yₙ repeatedly in an alternate fashion as shown in FIG. 22. In each sustain stage I, the number of sustain pulses IP to be applied to each pair of row electrodes (X, Y) is equal to a number corresponding to the luminance weight of that subfield as shown in FIG. 21.

Suppose, for example, that the number of sustain pulses IP to be applied to a pair of electrodes (X, Y) at the sustain stage I of the subfield SF1 in FIG. 21 is “1.” Then, in the sustain stages I of the respective subfields, the sustain pulses IP are applied to each pair of row electrodes (X, Y) repeatedly at such number ratios as SF1:1, SF2:3, SF3:5, SF4:8, SF5:10, SF6:13, SF7:16, SF8:19, SF9:22, SF10:25, SF11:28, SF12:32, SF13:35, and SF14:39. Only those display cells P having their wall charges remaining, i.e., the display cells P in the lighting mode generate a sustain discharge each time a sustain pulse IP is applied thereto, and sustain the light-emitting state resulting from the sustain discharge.

Whether each display cell P is set to the lighting mode or the extinction mode at the address stage W depends on the pixel drive data GD which is generated based on the input video signal. This 14-bit pixel drive data GD has 15 possible patterns in FIG. 20. The 15 patterns of pixel drive data GD in FIG. 20 always contain one or no bit of logic level 1 of the first bit to the fourteenth bit. As indicated by black circles in FIG. 20, a selective erase address discharge is thus generated only in the address stage W of any one of the subfields SF1 to SF14. As a result, the display cells P which are initialized into the lighting mode in the first subfield SF1 maintain the lighting mode until a selective erase address discharge occurs, and generate a sustain discharge successively at the sustain stages I (indicated with while circles) of respective subfields occurring in the meantime. The luminance corresponding to the total number of sustain discharges generated within a single field (or single frame) display period is visualized.

Consequently, based on the 15 patterns of pixel drive data GD in FIG. 20, driving can be practiced in accordance with the light emission driving sequence shown in FIG. 21 to express 15 gradation-luminance levels as follows:

{0, 1, 4, 9, 17, 27, 40, 56, 75, 97, 122, 150, 182, 217, 255}

In the plasma display apparatus shown in FIG. 19, the rear edges of the last sustain pulses IP_{E} to be applied as shown in FIG. 22, of the sustain pulses IP to be applied in the sustain stage I of each subfield SF, are modified in waveform in accordance with a lighting load level.

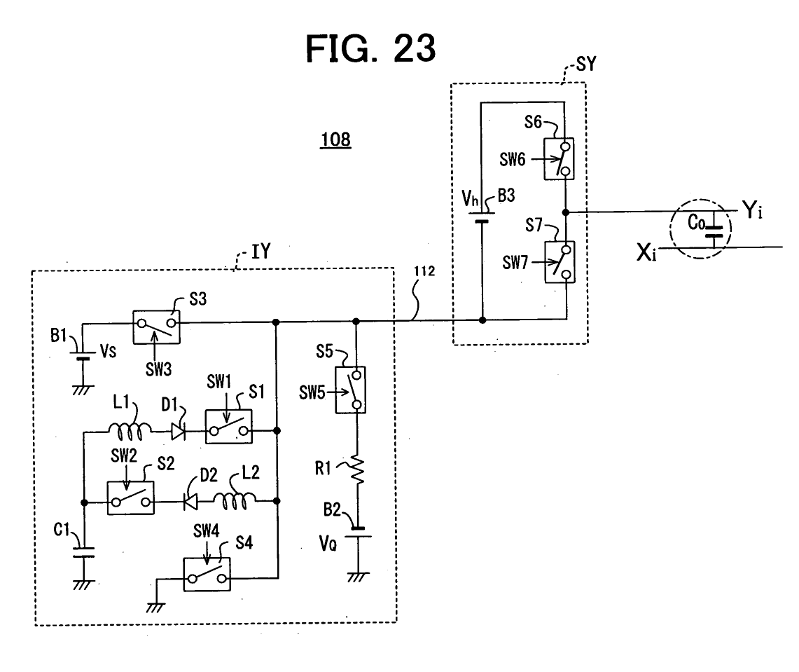

FIG. 23 is a diagram showing a sustain pulse generating circuit IY for generating sustain pulses IP and IP_{E} as described above and a scan pulse generating circuit SY for generating a scan pulses SP, as extracted from the internal configuration of the Y-row electrode drive circuit 108.

In FIG. 23, the sustain pulse generating circuit IY comprises direct-current power supplies B1 and B2, switching elements S1 to S5, coils L1 and L2, diodes D1 and D2, a resistor R1, and a capacitor C1 which is grounded to a ground potential at one end. The power supply B1 is a direct-current power supply for generating a direct-current potential V_{S}, and is grounded at its negative terminal. The power supply B2 is a direct-current power supply for generating a direct-current potential V_{Q}, and is grounded at its positive terminal. The switching element S1 is controlled to an on/off state in accordance with a switching signal SW1 which is a control signal supplied from the drive control circuit 102. The switching element S1 applies a potential occurring on the other end of the capacitor C1 to a line 112 through the coil L1 and the diode D1 as long as it is on. The switching element S2 is controlled to an on/off state in accordance with a switching signal SW2 which is a control signal supplied from the drive control circuit 102. The switching element S2 applies a potential on the line 112 to the other end of capacitor C1 through the coil L2 and the diode D2 as long as it is on.

The switching element S3 is controlled to an on/off state in accordance with a switching signal SW3 which is a control signal supplied from the drive control circuit 102. The switching element S3 applies the potential V_{S} on the positive terminal of the power supply B1 to the line 112 as long as it is on. The switching element S4 is controlled to an on/off state in accordance with a switching signal SW4 which is a control signal supplied from the drive control circuit 102. The switching element S4 grounds the line 112 to the ground potential as long as it is on. The switching element S5 is controlled to an on/off state in accordance with a switching signal SW5 which is a control signal supplied from the drive control circuit 102. The switching element S5 applies the potential (−V_{Q}) on the negative terminal of the power supply B2 to the line 112 through the resistor R1 as long as it is on.

The scan pulse generating circuit SY comprises a power supply B3 for generating a direct-current potential Vₕ, and switching elements S6 and S7. The negative terminal of the power supply B3 is connected with the line 112. The switching element S6 is controlled to an on/off state in accordance with a switching signal SW6 which is a control signal supplied from the drive control circuit 102. The switching element S6 applies the potential Vₕ on the positive terminal of the power supply B3 to the row electrode Y as long as it is on. The switching element S7 is controlled to an on/off state in accordance with a switching signal SW7 which is a control signal supplied from the drive control circuit 102. The switching element S7 applies the potential on the line 112 to the row electrode Y as long as it is on.

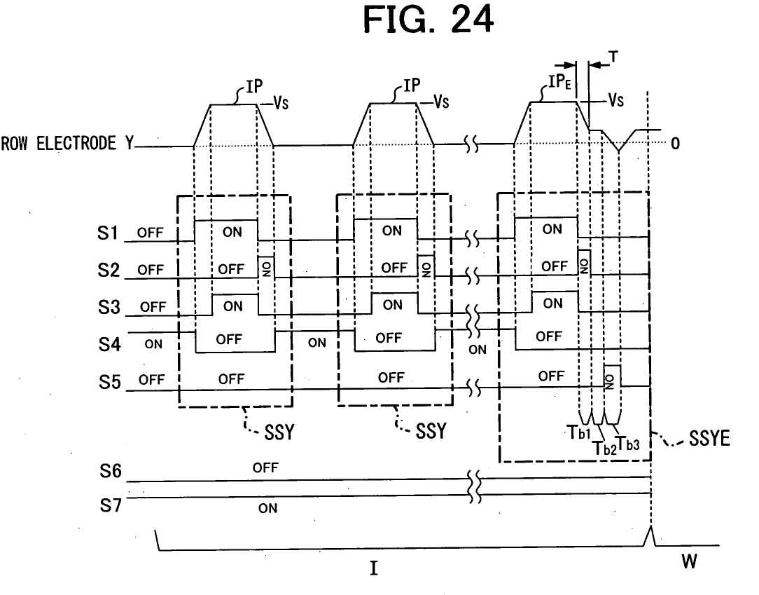

FIG. 24 is a chart showing the operation by which the sustain pulse generating circuit IY generates the sustain pulses IP and IP_{E}.

At the sustain stage I of each of the subfields SF, the drive control circuit 102 controls the switching element S6 of the scan pulse generating circuit SY to an OFF state, and the switching element S7 to an ON state.

The drive control circuit 102 then performs a switching control in accordance with a switching sequence SSY, as shown in FIG. 24, for the switching elements S1 to S5 of the sustain pulse generating circuit IY.

In response to the switching sequence SSY, the switching element S4 is initially turned from ON to OFF, and the switching element S1 is turned ON. A current resulting from charge stored in the capacitor C1 flows into display cells through the coil L1, the diode D1, the switching elements S1 and S7, and the row electrode Y. As a result, a potential on the row electrode Y gradually increases as shown in FIG. 24. Next, the switching element S3 is turned ON, and the potential V_{S} on the positive terminal of the power supply B1 is applied to the row electrode Y through the switching elements S3 and S7. Consequently, the potential on the row electrode Y reaches the potential V_{S}, the peak potential of the sustain pulse. After that, the switching elements S1 and S3 are turned OFF, and the switching element S2 is turned ON. A current resulting from charge stored in a load capacitance C0 between the row electrodes X and Y thus flows into the capacitor C1 through the row electrode Y, the switching element S7, the coil L2, the diode D2, and the switching element S2. The potential on the row electrode Y gradually decreases from the potential V_{S} as shown in FIG. 24 due to the charging operation of the capacitor C1. Subsequently, the switching element S4 is turned ON, and the row electrode Y is grounded to the ground potential (0 V). According to the switching operation under the switching sequence SSY, a sustain pulse IP having a waveform such that the pulse front edge and rear edge make a slow potential change as shown in FIG. 24 is generated.

In the sustain stage I of each subfield, the drive control circuit 102 repeats the switching control of the foregoing switching sequence SSY intermittently by the number of times corresponding to the luminance weight of that subfield. As a result, the sustain pulse generating circuit IY applies the sustain pulse IP to the row electrode Y repeatedly by the number of times corresponding to the luminance weight of that subfield.

When generating the last sustain pulse IP_{E} to be applied in the sustain stage I of each subfield, the drive control circuit 102 performs a switching control in accordance with a switching sequence SSYE instead of the switching sequence SSY.

According to the switching sequence SSYE, the switching element S4 is initially turned from ON to OFF, and the switching element S1 is turned ON. A current resulting from the charge stored in the capacitor C1 flows into display cells through the coil L1, the diode D1, the switching elements S1 and S7, and the row electrode Y. As a result, the potential on the row electrode Y gradually increases as shown in FIG. 24. Next, the switching element S3 is turned ON for a predetermined period, and the potential V_{S} on the positive terminal of the power supply B1 is applied to the row electrode Y through the switching elements S3 and S7. The potential on the row electrode Y is thus maintained to the potential V_{S} for the predetermined period. After that, the switching elements S1 and S3 are turned OFF, and the switching element S2 is turned ON for a period T corresponding to the lighting load level indicated by a lighting load level signal LOD for that subfield. The higher the lighting load level indicated by the lighting load level signal LOD is, the shorter the period T is. Since the switching element S2 is turned ON, a current resulting from the charge stored in the load capacitance C₀ between the row electrodes X and Y flows into the capacitor C1 through the row electrode Y, the switching element S7, the coil L2, the diode D2, and the switching element S2 only during the period T. The potential on the row electrode Y gradually decreases from the potential V_{S} over the period T as shown in FIG. 24 due to the charging operation of the capacitor C1 (first potential decrease period T_{b1}). Next, all the switching elements S1 to S5 are set to an OFF state for a predetermined period, during which the line 112 becomes high in impedance. This stops the potential decrease on the row electrode Y, and the state of the potential at the stop time point is maintained for the foregoing predetermined period (constant potential period T_{b2}). After that, only the switching element S5 of S1 to S5 is turned ON, and the potential (−V_{Q}) on the negative terminal of the power supply B2 is applied to the row electrode Y through the resistor R1, the switching element S5, the line 112, and the switching element S7. As a result, the potential on the row electrode Y gradually decreases again and reaches a negative potential (second potential decrease period T_{b3}).

According to the switching sequence SSYE, a sustain pulse IP_{E} having a waveform such that the pulse front edge and rear edge make a slow potential change as shown in FIG. 24 is thus generated. The ratio of potential change with a lapse of time at the pulse rear edge of this sustain pulse IP_{E} is lower than that of the other sustain pulses IP. That is, the rear edge of the last sustain pulse IP_{E} to be applied in each sustain stage I decreases in potential more gradually than the rear edges of the other sustain pulses IP do.

When a sustain pulse IP_{E} is applied, display cells P that are in the lighting mode generate their last sustain discharge in the period of the front edge of this sustain pulse IP_{E}, and then produce weak discharge in the period of the rear edge (T_{b1} to T_{b3}). The weak discharge eliminates part of the wall charges formed in the display cells, thereby adjusting the amount of wall charge in each of the display cells P to an appropriate amount, i.e., so that selective erase address discharge can be generated without fail, without generating error discharge in the following address stage W. Moreover, the rear edge of the sustain pulse IP_{E} is provided with the constant potential period T_{b2} in FIG. 24 so that a predetermined potential is applied throughout the constant potential period T_{b2}. This makes it possible to adjust the amount of wall charge in each of the display cells P to an appropriate amount regardless of temperature variation of the panel, secular change, etc.

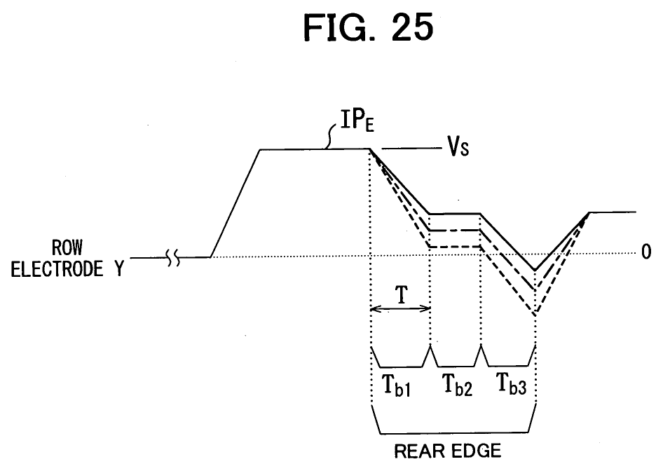

In the sustain stage I of each subfield, the amount of current to flow the PDP 110 at the time of the sustain discharge varies depending on the number of cells which are in the lighting mode of the display cells P_{(1,1)} to P_{(n, m)}, or the lighting load level. The pulse rear edge (T_{b1} to T_{b3}) of the sustain pulse IP_{E} changes in waveform accordingly as shown in FIG. 25. More specifically, if the lighting load level is as relatively low as L1, the pulse rear edge (T_{b1} to T_{b3}) of the sustain pulse IP_{E} shows such a waveform as shown by the full line in FIG. 25. If the lighting load level is as relatively high as L3, the pulse rear edge (T_{b1} to T_{b3}) of the sustain pulse IP_{E} shows such a waveform as shown by the dotted line in FIG. 25. If the lighting load level is L2, or intermediate between the foregoing L1 and L3, the pulse rear edge (T_{b1} to T_{b3}) of the sustain pulse IP_{E} shows such a waveform as shown by the dashed line in FIG. 25.

In other words, the higher the lighting load level is, the higher the ratio of potential decrease with a lapse of time in the first potential decrease period T_{b1} of the pulse rear edge of the sustain pulse IP_{E} becomes. The potential to be applied to the row electrode Y in the next constant potential period T_{b2} therefore varies with the lighting load level, which makes it difficult to control the amount of wall charge in each of the display cells P to an appropriate amount.

Then, in the plasma display apparatus shown in FIG. 19, the first potential decrease period T_{b1} of the last sustain pulse IP_{E} in the sustain stage of each subfield is adjusted in length in accordance with the lighting load level in that subfield. The potential in the constant potential period T_{b2} of the last sustain pulse IP_{E} is thereby maintained to a predetermined potential regardless of the lighting load level.

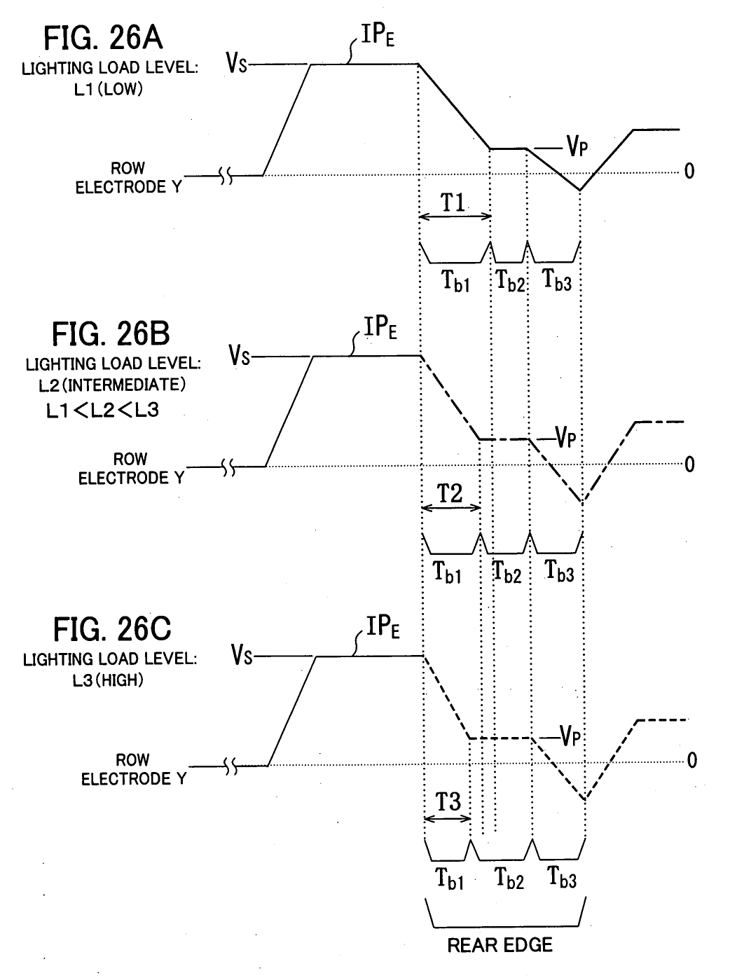

For example, if the lighting load level signal LOD₁ indicates a relatively small lighting load level L1, the drive control circuit 102 sets the switching element S2 to an ON state for a period T1 as shown in FIG. 26A during the first potential decrease period T_{b1} of the rear edge of the last sustain pulse IP_{E} to be applied in the sustain stage I of the subfield SF1. Consequently, in the first potential decrease period T_{b1}, the potential on the row electrode Y gradually decreases from the state of the potential V_{S} over the period T1 and reaches a predetermined potential V_{P}. Then, in the subsequent constant potential period T_{b2}, the predetermined potential V_{P} as described above is applied to the row electrode Y.

Moreover, if the lighting load level signal LOD₁ indicates the lighting load level L2 (L1<L2), the drive control circuit 102 turns on the switching element S2 for a period T2 as shown in FIG. 26B (T1>T2) during the first potential decrease period T_{b1} of the rear edge of the sustain pulse IP_{E} to be applied in the sustain stage I of the subfield SF1. Consequently, in this first potential decrease period T_{b1}, the potential on the row electrode Y gradually decreases from the state of the potential V_{S} over the period T2 as shown by the dashed line of FIG. 26B. The lighting load level L2 is greater than L1, and thus the ratio of potential decrease in the first potential decrease period T_{b1} is higher. Since the length (T2) of the first potential decrease period T_{b1} is shortened accordingly, however, the potential immediately after the end of the first potential decrease period T_{b1} is the same predetermined potential V_{P} as in FIG. 26A.

If the lighting load level signal LOD₁ indicates a relatively large lighting load level L3 (L2<L3), the drive control circuit 102 turns on the switching element S2 for a period T3 as shown in FIG. 26C (T2>T3) during the first potential decrease period T_{b1} of the rear edge of the sustain pulse IP_{E} to be applied in the sustain stage I of the subfield SF1. Consequently, in the first potential decrease period T_{b1}, the potential on the row electrode Y gradually decreases from the state of the potential V_{S} over the period T3 as shown by the broken line of FIG. 26C. The lighting load level L3 is greater than L2, and thus the ratio of potential decrease in the first potential decrease period T_{b1} is higher. Since the length (T3) of the first potential decrease period T_{b1} is shortened accordingly, however, the potential immediately after the end of the first potential decrease period T_{b1} is the same predetermined potential V_{P} as in FIG. 26B.

In other words, based on the lighting load level (the total number of display cells P in the lighting mode) measured for each subfield, the drive control circuit 102 makes such a waveform adjustment as described above on the rear edge of the last sustain pulse IP_{E} to be applied in the sustain stage I of that subfield. That is, the drive control circuit 102 makes an adjustment so that the higher the lighting load level in that subfield is, the shorter the length of the initial potential decrease period (the first potential decrease period T_{b1}) at the rear edge of the foregoing sustain pulse IP_{E} becomes. The potential in the constant potential period T_{b2} of the last sustain pulse IP_{E} is thus maintained to the predetermined potential V_{P} regardless of the lighting load level.

According to the present invention, it is therefore possible to generate stable discharge all the time regardless of temperature variation, secular change, and the lighting load level.

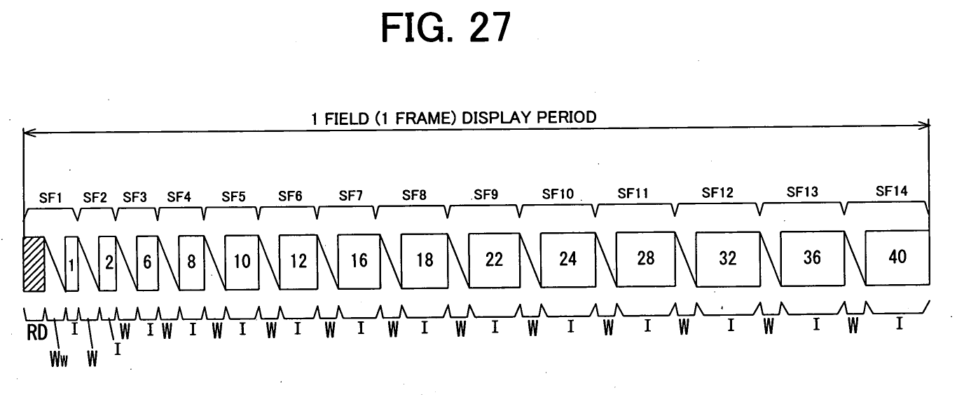

In the foregoing embodiment, the drive control circuit 102 is configured to drive the PDP 110 in accordance with the light emission driving sequence as shown in FIG. 21. However, it may drive the PDP 110 in accordance with another light emission driving sequence as shown in FIG. 27 instead.

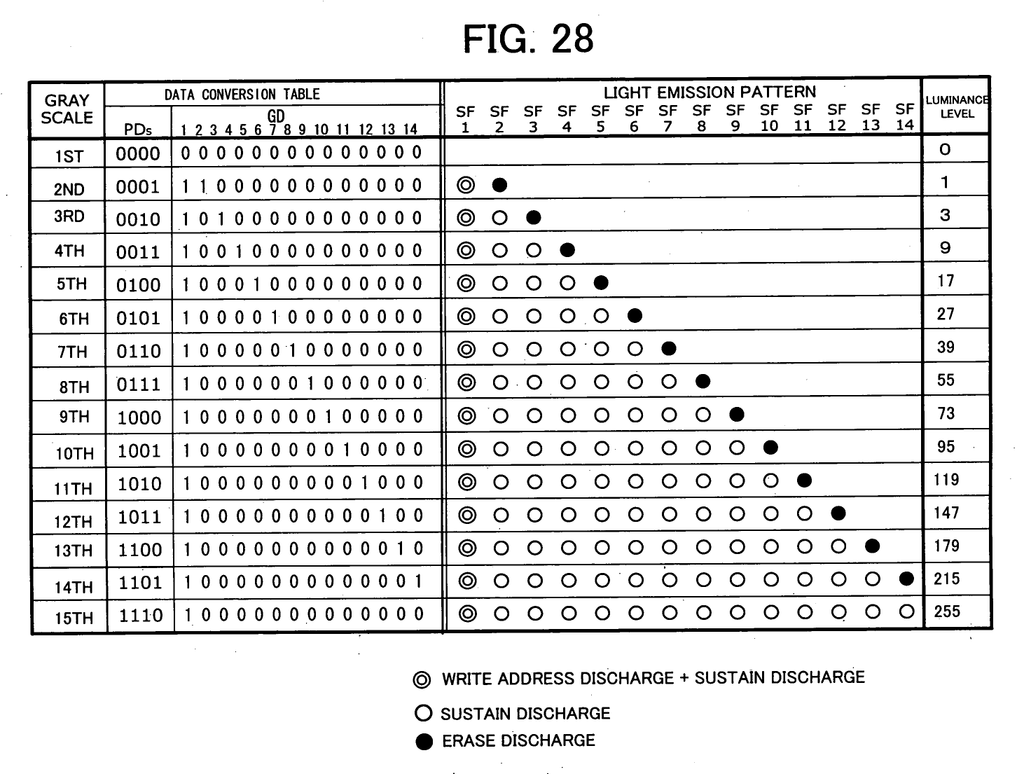

When driving the PDP 110 according to the light emission driving sequence of FIG. 27, the pixel drive data generating circuit 130 converts multi-gradation pixel data PD_{S} into 14-bit pixel drive data GD in accordance with a data conversion table shown in FIG. 28, and supplies it to the memory 104 and the lighting load measuring circuit 105.

At the first subfield SF1 in a single field (single frame) display period shown in FIG. 27, the drive control circuit 102 supplies the panel driver with various types of control signals for driving for each of a reset stage RD, a selective write address stage W_{W}, and a sustain stage I in succession. Moreover, in each of the subfields SF2 to SF14, it supplies the panel driver with various types of control signals for driving for each of an address stage W and a sustain stage I in succession.

In FIG. 27, at the reset stage RD of the first subfield SF1, reset discharge for erasing wall charges in all the display cells P is generated to initialize all the display cells P into an extinction mode. Next, in the selective write address stage W_{W} of the subfield SF1, the Y-row electrode drive circuit 108 selectively applies a scan pulse to each of the row electrodes Y₁ to Yₙ in succession. In the meantime, the column electrode drive circuit 106 initially converts pixel drive data bits corresponding to the subfield SF1 into pixel data pulses DP having pulse voltages corresponding to their logic levels. For example, when a pixel drive data bit of logic level 1 for setting a display cell P to the lighting mode is supplied, the column electrode drive circuit 106 converts the same into a pixel data pulse of high voltage. In the case of a pixel drive data bit of logic level 0 for setting to the extinction mode, on the other hand, it converts the same into a pixel data pulse of low voltage (0 V). The column electrode drive circuit 106 then applies these pixel data pulses to the column electrodes D₁ to Dₘ in units of a single display line (m pulses) in succession in synchronization with the timing of application of the scan pulse. Display cells P to which pixel data pulses DP of high voltage for setting to the lighting mode are applied simultaneously with the scan pulse generate selective write address discharge. Wall charges are formed in these display cells P in response to the selective write address discharge, so that the display cells P are set to the lighting mode. Meanwhile, display cells P to which pixel data pulses of low voltage (0 V) for setting to the extinction mode are applied simultaneously with the scan pulse will not generate the selective write address discharge. The display cells P thus maintain their immediately preceding states, i.e., the state of the extinction mode to which they are initialized at the reset stage RD.

The operations at the sustain stages I and the address stages W of the respective subfields SF1 to SF14 are the same as with the light emission driving sequence shown in FIG. 21. Description of the operations will thus be omitted.

When the PDP 110 is driven in accordance with 15 types of pixel drive data GD as shown in FIG. 28, initially, in the first subfield SF1, write address discharge (indicated with a double circle) is generated in each display cell P selectively (excluding the first level which is to express luminance level 0). By the write address discharge, the display cells P that are initialized to the extinction mode in the reset stage RD are brought into the state of the lighting mode. Then, selective erase address discharge (indicated with a black circle) is generated in the address stage W of any one of the subfield SF2 to SF14 selectively, so that the display cells P are set to the extinction mode. That is, each display cell P is set to the lighting mode in consecutive subfields as many as corresponds to its intermediate luminance to express, and causes light emission ascribable to sustain discharges (indicated with a while circle) repeatedly as many times as the numbers of times assigned to these respective subfields. The luminance corresponding to the total number of sustain discharges generated within a single field (or single frame) display period is visualized. According to the 15 types of emission patterns resulting from the first to fifteenth levels of driving shown in FIG. 28, 15 levels of intermediate luminance are thus expressed corresponding to the total numbers of sustain discharges generated in the respective subfields represented by the while circles.

Even when performing the driving as shown in FIGS. 27 and 28, waveform adjustment processing as shown in FIGS. 26A to 26C is applied to the first potential decrease period T_{b1} at the rear edge of the last sustain pulse IP_{E} in the sustain stage I of each subfield.

This application is based on Japanese Applications No. 2006-255632 and No. 2006-278770 which are hereby incorporated by reference.

What is claimed is:

1. A plasma display apparatus for performing a gradation display on a plasma display panel by constructing a plurality of subfields including an address period and a sustain period in each field of an input video signal, said plasma display panel having a plurality of row electrode pairs constituting a plurality of display lines and a plurality of column electrodes that intersect with each of the row electrode pairs so as to form display cells at the intersection portions, the apparatus comprising:
an address portion which generates, in the address period, address discharge in each of the display cells selectively in accordance with pixel data based on the video signal; and
a sustain portion which applies, in the sustain period, a sustain pulse to between row electrodes constituting the row electrode pairs by a predetermined number of times which is preset for each of the subfields, wherein
said sustain portion sets a length of a front-edge period of the applied sustain pulse in accordance with a load level of the plasma display panel in each of the subfields.

2. The plasma display apparatus according to claim 1, wherein said sustain portion comprises:
a first transition potion for causing a resonant transition of a potential of each of the row electrodes from a first potential to a second potential;
a first clamping portion for clamping the potential of each of the row electrodes to the second potential;
a second transition portion for causing a resonant transition of the potential of each of the row electrodes from the second potential to the first potential; and
a second clamping portion for clamping the potential of each of the row electrodes to the first potential, and
generates the sustain pulse by successively performing a first stage of causing transition from the first potential to the second potential, a second stage of clamping to the second potential, a third stage of causing transition from the second potential to the first potential, and a fourth stage of clamping to the first potential.

3. The plasma display apparatus according to claim 2, wherein said sustain portion sets a longer time to transit from the first potential to the second potential and clamp to the second potential in a subfield where the load level is large than in a subfield where the load level is small.

4. The plasma display apparatus according to claim 2, wherein the sustain portion delays the timing to clamp to the second potential in a subfield where the load level is large, as compared to a subfield where the load level is small.

5. The plasma display apparatus according to claim 1, wherein the sustain portion includes a load level detection circuit for detecting, as the load level, a number of display cells to be set to a lighting state of all the display cells in the plasma display panel in accordance with the video signal for each of the subfields.

6. A plasma display apparatus for performing a gradation display on a plasma display panel by constructing a plurality of subfields including an address period and a sustain period in each field of an input video signal, said plasma display panel having a plurality of row electrode pairs constituting a plurality of display lines and a plurality of column electrodes that intersect with each of the row electrode pairs so as to form display cells at the intersection portions, the apparatus comprising:
an address portion which generates, in the address period, address discharge in each of the display cells selectively in accordance with pixel data based on the video signal; and
a sustain portion which applies, in the sustain period, a sustain pulse to between row electrodes constituting the row electrode pairs by a predetermined number of times which is preset for each of the subfields, wherein
said sustain portion sets a length of a front-edge period of the applied sustain pulse in accordance with a first load level of the plasma display panel for each of the subfields and a second load level for each display line of the plasma display panel.

7. The plasma display apparatus according to claim 6, wherein said sustain portion comprises:
a first transition portion for causing a resonant transition of potentials of the row electrodes from a first potential to a second potential;
a first clamping portion for clamping the potentials of the row electrodes to the second potential;
a second transition portion for causing a resonant transition of the potentials of the row electrodes from the second potential to the first potential; and
a second clamping portion for clamping the potentials of the row electrodes to the first potential, and
generates the sustain pulse by successively performing a first stage of causing transition from the first potential to the second potential, a second stage of clamping to the second potential, a third stage of causing transition from the second potential to the first potential, and a fourth stage of clamping to the first potential; and
said sustain portion sets the length of the leading-edge period of the sustain pulse by modifying timing of clamping to the second potential in accordance with the first load level for each of the subfields and the second load level for each display line.

8. A method for dividing a display period for each field of an input video signal into a plurality of subfields, and driving a plasma display panel for each of the subfields, said plasma display panel having a plurality of row electrode pairs constituting a plurality of display lines and a plurality of column electrodes that intersect with each of the row electrode pairs so as to form display cells at the intersection portions, the method comprising the steps of:
executing, in each of the subfields, an address stage for setting each of the display cells to either one of a lighting mode and an extinction mode in accordance with pixel data on each pixel corresponding to the input video signal, and a sustain stage for applying a sustain pulse to between row electrodes constituting the row electrode pairs by a predetermined number of times which is preset for each of the subfields, thereby making display cells in the lighting mode alone generate sustain discharge repeatedly, wherein:
a rear edge of a last one of the sustain pulses applied in the sustain stage is composed of a first potential decrease period where a potential to be applied to the row electrodes decreases gradually with a lapse of time, a constant potential period subsequent to the first potential decrease period, where the potential to be applied to the row electrodes remains constant during a predetermined period, and a second potential decrease period subsequent to the constant potential period, where the potential to be applied to the row electrodes decreases gradually with a lapse of time; and
in each of the subfields, the total number of display cells which are in the lighting mode is measured as a lighting load level, and a length of the first potential decrease period is adjusted in accordance with the lighting load level.

9. The method of driving a plasma display panel according to claim 8, wherein the row electrodes are set to a high impedance state for the predetermined period so that the potential of the last sustain pulse remains constant for the predetermined period in the constant potential period.

10. The method of driving a plasma display panel according to claim 8, wherein the length of the first potential decrease period is made shorter when the lighting load level is large than when it is small.

11. The method of driving a plasma display panel according to claim 8, wherein:
a reset stage of initialing all the display cells into the state of the lighting mode is performed prior to the address stage only in the first subfield of each individual field; and
each of the display cells is selectively changed from the state of the lighting mode to the state of the extinction mode only in the address stage of one of the plurality of subfields in each field.

12. The method of driving a plasma display panel according to claim 8, wherein:
a reset stage of initialing all the display cells into the state of the extinction mode is performed prior to the address stage only in the first subfield of each individual field;
each of the display cells is selectively changed from the state of the extinction mode to the state of the lighting mode in the address stage of the first subfield; and
each of the display cells is selectively changed from the state of the lighting mode to the state of the extinction mode only in the address stage of one of subfields succeeding the first subfield in each field.

13. A method for performing a gradation display on a plasma display panel by constructing a plurality of subfields including an address period and a sustain period in each field of an input video signal, wherein
a length of a front-edge period of a sustain pulse applied in the sustain period is set in accordance with a load level of the plasma display panel in each of the subfields.

14. A method for performing a gradation display on a plasma display panel by constructing a plurality of subfields including an address period and a sustain period in each field of an input video signal, wherein
a length of a front-edge period of the applied sustain pulse is set in accordance with a first load level of the plasma display panel for each of the subfields and a second load level for each display line of the plasma display panel.
